(19) United States
(12) Patent Application Publication
(10) Pub. No.: US 2026/0028154 A1
(43) Pub. Date: Jan. 29, 2026

(54) CONTAINER MOUNTING AND LOCOMOTING SYSTEM

(71) Applicant: KETER HOME AND GARDEN PRODUCTS LTD., Herzliya (IL)

(72) Inventors: Yaron BRUNNER, Kibbutz Gvat (IL); Ayala VARDI-BOUGAY, Kefar Veradim (IL); Uri PARIZER, Kibbutz Hukok (IL); Omer MENASHRI, Kibbutz Afikim (IL)

(73) Assignee: KETER HOME AND GARDEN PRODUCTS LTD., Herzliya (IL)

(21) Appl. No.: 19/350,111

(22) Filed: Oct. 6, 2025

Related U.S. Application Data
(63) Continuation of application No. 18/567,337.

(30) Foreign Application Priority Data
Jul. 8, 2021 (IL) 284713

(51) Int. Cl. B65D 25/20; B25H 3/02; B62B 1/14; B62B 5/06; B65D 21/02; B65D 43/16

(52) U.S. Cl. CPC B65D 25/20; B62B 1/14; B62B 5/067; B65D 21/0209; B65D 43/16; B25H 3/02; B65D 2543/00194

(57) ABSTRACT

A container assembly includes a container with a back wall having a back face with at least a pair of spaced apart top mounting sockets projecting backwards from an upper portion of said back face, each mounting socket comprises at least a front wall portion and a spaced apart back wall portion, with a bottom mounting opening therebetween. A locomoting unit includes a support frame that comprises a pair of wheels and a manipulating handle, at least a pair of coplanar container mounts disposed at a top portion of the support frame and projecting from a front surface thereof. Each container mount may have an upward projecting tongue arrestable within a top mounting socket of a container. Each of the top mounting sockets is mountable over the container mount. A back surface of the container mount may be spaced from a front surface of the support frame.

### TECHNOLOGICAL FIELD

The present disclosure concerns a container mounting and locomoting system.

### BACKGROUND ART

A wide variety of containers configured with a locomotive arrangement are known in the art.

References considered to be relevant as background to the presently disclosed subject matter are listed below:
U.S. Pat. No. 9,643,629
U.S. Pat. No. 10,703,534
EP3820653A1
U.S. Pat. No. 10,793,172
US2020/398879
U.S. Pat. No. 10,160,471
U.S. Pat. No. 7,066,475

Acknowledgement of the above references herein is not to be inferred as meaning that these are in any way relevant to the patentability of the presently disclosed subject matter.

### BACKGROUND

U.S. Pat. No. 9,643,629 discloses an apparatus for transporting articles between working locations includes one or more rotatable ground engaging wheels mounted towards the bottom of the apparatus for rotation about an axis to provide rolling support for the apparatus, a manually engageable pulling handle, a frame, at least one container connected to the frame, and an audio playback device. The audio playback device includes one or more speakers and is configured to be releasably connected to the apparatus. The pulling handle and the one or more ground engaging wheels are arranged to enable a user to manually pull the pulling handle generally rearwardly so as to tilt the apparatus rearwardly to a tilted rolling movement position, thereby enabling the user to roll the apparatus to a desired location by pushing or pulling the pulling handle in a desired direction.

U.S. Pat. No. 10,703,534 discloses a coupling mechanism for detachably attaching two or more utility modules to one another, utility assembles, mobile carriers and other attachable modules and articles.

EP3820653A1 discloses the use of a cart for transporting loads, preferably tool cases, as a tray system, said cart being secured to a wall by means of at least one adjustable fastening device that is arranged on the wall.

U.S. Pat. No. 10,793,172 discloses container assemblies, including at least two containers detachably attached to one another by locking arrangements.

US2020/398879 discloses a system for transporting a number of assortment boxes or toolboxes comprises at least one frame part and at least one transportation unit. The frame part comprises a top, a bottom, and a front opening. The frame part forms at least one compartment adapted to contain at least one assortment box or toolbox, wherein the front opening is dimensioned for receiving and introducing the assortment box or toolbox into the compartment. The transportation unit comprises a carrying means, a stabilisation means, wheels, a handle, and an arm. A distal end of the arm is connected to the carrying means and the wheels. A proximal end of the arm is connected to the handle. The carrying means is adapted to carry the bottom of the frame part. The stabilisation means is arranged at the arm, where the stabilization means is adapted to fixate the frame part to said transportation unit.

US2018/044059 discloses a container assembly including a container for storage and transport of goods including at least one side wall and a bottom wall defining together an interior space and a cover for closing the opening, having a top surface. The cover may include at least one latch member movable between at least a first position and a second position. The container may also include a retaining member on the at least one side wall and positioned parallel to the latch member such that the latch member is configured for engaging with a retaining member of another container to connect the container to the at least one other container.

U.S. Pat. No. 10,160,471 discloses a rolling container includes a body having an upper opening, a lid pivotally coupled to the body, a wheel coupled to the body, configured for rolling the body thereon, a maneuvering handle pivotally coupled to the body, and a handle pivot mechanism configured to pivot the maneuvering handle away from the body when the lid is opened.

U.S. Pat. No. 7,066,475 discloses a wheeled device useful for transporting and storing a wide variety of cargos, including cartons, crates, boxes and the like and which finds special utility in transporting and stowing musical equipment, such as amplifiers and speakers. The instant device includes vertical and horizontal elements, and further includes support arms having a variable width by which the cargo may be grasped and firmly held in place on the device. Use of a device according to the invention causes optimization of floor space required to store items on a moveable base.

### GENERAL DESCRIPTION

The present disclosure is directed to a container comprising at back wall thereof a suspension mechanism configurable for detachably attaching to a carrying structure for suspension therefrom.

Herein the specification and claims the term ‘container’ is used in a broad sense and denotes any sort of utility container, such as a toolbox, power generator, hand tool, power tool, storage unit, chest of drawers, etc., regardless of its function, shape and number of walls.

The term ‘carrying structure’ as used herein the specification and claims denotes any platform to which at an upright position a container according to the disclosure can be detachably articulated. A carrying structure can be, for example, a wall of a building/structure, a portion of a vehicle, a support structure of a cart (e.g. a hand truck), a wall of a cabinet, a work stand, etc.

According to a first aspect of the disclosure there is a container comprising at least a back wall having a back face with at least a pair of spaced apart top mounting sockets projecting backwards from an upper portion of said back face; each mounting socket being configured with at least a front wall portion and a spaced apart back wall portion, with a bottom mounting opening therebetween, configurable for mounting over a container mount.

According to an embodiment of the first aspect of the disclosure, the container is further configured with at least one bottom mounting socket, wherein said at least one bottom mounting socket has a bottom opening for receiving therein a bottom bracket.

According to a second embodiment of the first aspect of the disclosure, the container can further be configured at a back wall thereof with a locking slot configurable for arresting engagement with a locking latch slidably displaceable therein.

According to a second aspect of the disclosure there is container locomoting unit comprising a support frame configured with a pair of wheels and a manipulating handle; at least a pair of coplanar container mounts disposed at a top portion of the support frame and projecting from a front surface thereof, each container mount having an upward projecting tongue configurable for arresting within a top mounting socket of a container.

According to an embodiment of the second aspect of the disclosure, the support frame is further configured at a bottom portion thereof with one or more container stabilizers projecting from the front surface of the support frame and having a T-like cross section.

The support frame can be configured with a locking latch disposed between the container mounts and displaceable from a front facing wall surface, behind the container mounts, between a retracted position and a projecting position, wherein at the projecting positioning said locking latch projects into arresting engagement with a locking slot configured at a back wall of a container engaged with the locomoting unit.

According to a third aspect of the disclosure, there is provided a set of wall container mounts, each wall container mount configured with a wall mounting surface at a back side thereof and a wall articulation arrangement, and having a flat front wall surface with a container mounting bracket projecting upwards at a top portion of the front wall and configurable for arresting within a top mounting socket of a container.

According to a particular configuration, said mounting bracket is further configured with lateral projecting wings imparting it a T-like cross section.

Yet an aspect of the disclosure is directed to a container set comprising:
at least one container comprising at least a back wall having a back face with at least a pair of spaced apart top mounting sockets projecting backwards from an upper portion of said back face; each mounting socket configured with at least a front wall portion and a spaced apart back wall portion, with a bottom mounting opening therebetween, configurable for mounting over a wall container mount;
a container suspension arrangement comprising on or both of a container locomoting unit and a set of wall container mounts, wherein said locomoting unit comprises a support frame configured with a pair of wheels and a manipulating handle; at least a pair of coplanar container mounts disposed at a top portion of the support frame and projecting from a front surface thereof, each container mount having an upward projecting togue configurable for arresting within a top mounting socket of a container; and said set of wall container mounts, comprises at least a pair of wall container mount, each configured with a wall mounting surface at a back side thereof and a wall articulation arrangement, and having a flat front wall surface with a mounting bracket projecting upwards at a top portion of the front wall; said mounting bracket further configured with lateral projecting wings imparting it a T-like cross section.

Articulating a container according to the disclosure to a locomoting unit according to the disclosure or to a wall container mount according to the disclosure takes place by placing the bottom mounting opening of the container over the container mounting brackets of the locomoting unit or of the wall container mount, respectively, and slidingly displacing the container vertically downwards.

Mounting the container over a locomoting unit takes place by placing the bottom mounting opening of the container over the container mounting brackets of the locomoting unit, and respectively the bottom opening of the at least one bottom mounting socket has a bottom opening over the container stabilizers of the support frame, and slidingly displacing the container vertically downwards.

Mounting the container over a wall container mount takes place by displacing the container downwards from a top end of the wall container mounts, such that the top mounting sockets displace vertically over a top end of the wall container mounts.

According to a further aspect of the disclosure there is a wall mounting bracket used with at least two container mounts, wherein said wall mounting bracket comprising a rigid support bar configured with a wall articulation face configurable for attaching to a bearing wall of a carrying structure, and a container mounts face; and wherein said wall mounting bracket is configurable for supporting at least two container mounts projecting from said container mounts face; said container mounts being spaced apart from one another and disposed coplanar, with a longitudinal axis thereof extending parallel with one another.

The arrangement is such that the container mounts of the wall mounting bracket are configured in compliance with any of the herein disclosed container mounts, wherein each container mount comprises an upward projecting tongue configurable for arresting within a top mounting socket of a container.

The term ‘bearing wall’ as used herein the specification and claims denotes any support structure suitable for articulation of a wall mounting bracket, e.g., a construction wall, a support frame, support studs, a hand truck, a vehicle support structure, a tool cart/box/cady, a support frame, etc., thereto.

Any one or more of the following features, designs and configurations can be associated with any one or more of the aspects of the present disclosure, individually or in various combinations thereof:
One or both of an inside front wall and an inside back wall of the mounting socket can taper upwards;
At a mounted position, the tapering wall portions of the socket bear over tapering wall surfaces of the mount;
The back wall portion of the mounting sockets can be a double wall;
The back wall of the mounting socket can be shorter than a front wall thereof;
The front wall portion of the mounting sockets can extend coplanar with an outside face of a back wall of the container;
The front wall of the mounting socket can be part of the back surface of the back wall;
The inner side walls of the socket can taper upwards, wherein a bottom portion thereof is wider than a top portion;
The mounting socket can be configured with one or more gliding surfaces to facilitate guidance and smooth mounting of the mounting socket over a wall container mount;
The at least two mounting sockets can extend at the same elevation;
The at least two mounting sockets can be symmetrically disposed over the back face of the container;
The mounting socket can have an open portion at a back wall thereof, configurable for mounting over a wall container mount having a T-like cross section;
The mounting socket can be configured with an upwardly tapering section;
The container can be configured with a top wall portion;
The top wall portion can be a lid pivotally hinged at a top of the back wall, and being displaceable between a closed position at which it bears over a top end of walls of the container, and at least a first open position at which it is disposed at an upright position;
The container can be articulated over a top wall of a similar container;
A second container can be detachably articulated over the top wall of the container;
At an assembled position, a lid of a container, that is articulated to the locomoting unit by a rear lid axle, can be pivotally opened into 90°;
The top mounting sockets can be leveled;
A longitudinal axis of the top mounting sockets and of the at least one bottom mounting socket are parallel with one another;
An outside, back wall surface of the bottom mounting socket can extend at the same plane of an outside face of the back wall of the container;
An outside, back wall surface of the bottom mounting socket can extend at the same plane of an inside front wall of the top mounting sockets;
The bottom opening extends from a support leg projecting from a bottom base of the container;
The bottom mounting socket can be configured with a T-like cross section;
The T-like cross section of the bottom mounting socket can be homogeneous along its longitudinal axis;
Inside edges of the bottom mounting socket can be chamfered;
Sliding axis of a top mounting sockets can coincide with a sliding axis of a bottom socket;
A front wall of the mounting socket can extend flush with a back face of a back wall of the container;
A back wall of the bottom mounting socket can extend flush with a back face of a back wall of the container;
A longitudinal axis of the mounting socket can be inclined with respect to the back wall of the container, whereby said longitudinal axis intersects a plane of the back wall of the container; this arrangement will provide some deformation of the back wall of the container for compensation over its weight when at a suspended position;
A back surface of the front wall of the mounting socket can be flat and smooth;
A lid of the container can be arrested at a 90° open position by a lid distinct position arresting mechanism;
The wheels of the locomoting unit can be mounted on an axle defining a wheel axis, said axis can extend above the container stabilizers;
The wheel axis can extend behind the front surface of the support frame;
The manipulating handle can be a telescopic handle, displaceable between a retracted position and at least one extended position;
The telescopic handle can be configured with two or more telescoping segments;
At a retracted position of the manipulating handle a bottom end thereof can extend equally-leveled or slightly shorter than a bottom support face of a container supported by the locomoting unit;
A point of ground contact of the wheels can extend equally-leveled or slightly higher than a bottom support face of a container supported by the locomoting unit;
The locking latch can be configured for horizontal sliding displacement;
The locking latch can be normally spring biased into its retracted position, wherein displacement into the retracted position is manually facilitated against a biasing force;
The locking latch can be configured with a top chamfered surface, slidably displaceable over a bottom wall portion of a locking slot of a container engageable with the locomoting unit, whereby the locking latch can displace into the retracted position upon a force applied thereto at a vertical direction, intersecting sliding direction of the locking tab;
The locking latch can be configured with a flat bottom surface, for arresting over a wall portion of a locking slot of a container engageable with the locomoting unit;
The locking latch can be configured at a top portion of the support frame;
The support frame can be configured with a footstep surface configured for assisting an individual to tilt the locomoting unit into an inclined pulling position, and to prevent displacement of the locomoting unit upon engaging/detaching a container;
The projecting height of the container's lid above a center of a rear lid pivot axle is similar or lesser than the distance between the center of the rear lid pivot axle to a front surface of the top telescoping segments of the telescopic handle;
Two or more wall container mounts can be interconnected with one another by a bridging portion;
A wall container mount can be integrated with a bubble level;
A front wall of the wall container mount can be flat and smooth;
The wall mounting surface of the wall container mounts can be flat;
A front wall and a wall mounting surface of the wall container mount taper, wherein the distance between the front wall and the wall mounting surface at a bottom portion of the wall container mount is greater than the distance between the front wall and the wall mounting surface at a top portion thereof;
The wall articulation arrangement of the wall container mount can be a graded aperture throughgoing between a wider opening at the front wall surface and a narrower opening at the wall mounting surface;
The overall thickness of the wall container mounts is greater projecting height of the container's lid above a center of a rear lid pivot axle, such that while suspended from a wall container mounts, the lid of a container can be pivoted into an open position;
The at least two container mounts can be integral with, or detachable from the support bar of the wall mounting bracket;
The support bar of the wall mounting bracket can be configured with two or more container mount receptacles;
The support bar of the wall mounting bracket can be configured with sockets for articulation with the bearing wall;
The support bar of the wall mounting bracket can be configured with a lock mechanism for selectively obstructing a mounting path of a container over said container mounts;
The lock mechanism can be configured with a positioning arrangement for distinctively arresting the lock mechanism at a respective closed position wherein the mounting path is obstructed, whereby a container cannot be displaced into mounting/unmounting position over the container mounts, and an open position wherein the mounting path is not obstructed, whereby a container can be freely mounted/unmounted;
The lock mechanism can be configured with a manipulating member for selective displacing the lock mechanism between its respective closed position and open position, said manipulating member being accessible also at the event of a container supported by the wall mounting bracket;
The manipulating member of the lock mechanism can be configured as a flag-like member disposed parallel with an obstructing member of the lock mechanism, and extending offset, so that at the open position the manipulating member is spaced from the wall articulation face of the wall mounting bracket;
The at least two container mounts can be configured with a wall mounting surface, whereby at an assembled position said wall mounting surface is flush with the wall articulation face of the wall mounting bracket;
Each of the at least two container mounts can be configured with one or more sockets for articulation with the bearing wall;
A back surface of the container mounts can extend spaced apart from the container mounts face;
The container mounts can be a monoblock unit extending along a longitudinal axis thereof;
A container mount can be configured for use in association with an auxiliary support mount independent of the associated container mount, wherein said auxiliary support mount is disposed coaxial with a longitudinal axis of the associated container mount;
The support bar of the wall mounting bracket can be secured to the bearing wall;
The support bar of the wall mounting bracket can be supported over the at least two support mounts;

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a top, front perspective view of a container according to an example of the disclosure;

FIG. 1B is a top, rear perspective view of the container of FIG. 1A;

FIG. 1C is a vertical section along line 1C-1C in FIG. 1B;

FIG. 1D is an enlarged view of the portion marked 1D in FIG. 1C;

FIG. 1E is an enlarged view of the portion marked 1D in FIG. 1C;

FIG. 1F is a planar view of FIG. 1C;

FIG. 1G is an enlarged view of the portion marked 1G in FIG. 1F;

FIG. 1H is an enlarged view of the portion marked 1H in FIG. 1F;

FIG. 1I is an enlarged view of a portion sectioned along line 1I-1I in FIG. 1D;

FIG. 1J is an enlarged view of a portion sectioned along line 1J-1J in FIG. 1C;

FIG. 2 is a bottom, rear perspective view of a bottom portion of the container of FIG. 1A;

FIGS. 3A and 3B are a front perspective view of a container locomoting unit, according to an example of the disclosure, with a manipulating handle at a retracted and an extended position, respectively;

FIG. 3C is a rear perspective view of FIG. 3B;

FIG. 4A is an enlargement of the portion marked 4A in FIG. 3B;

FIG. 4B is a vertical section through line 4A-4A in FIG. 4A, with a wheel removed for sake of clarity;

FIG. 4C is a vertical section through line 4C-4C in FIG. 4A, with a wheel removed for sake of clarity;

FIGS. 5A to 5D illustrate a container according to an aspect of the disclosure articulated to a locomoting unit according to another aspect of the disclosure, wherein:

FIG. 5A is a front perspective view with the manipulating handle at a retracted position;

FIG. 5B is a front perspective view with the manipulating handle at an extended position;

FIG. 5C is a rear perspective view of FIG. 5A;

FIG. 5D is a rear perspective view of FIG. 5B;

FIG. 6 is a planar side view of FIG. 5A;

FIG. 7A is a vertical section along line 7A-7A in FIG. 5A;

FIG. 7B is a vertical section along line 7B-7B in FIG. 5A;

FIG. 7C is an enlargement of the portion marked 7C in FIG. 7B;

FIG. 7D is an enlargement of the portion marked 7D in FIG. 7B;

FIG. 8A is a rear perspective view of FIG. 7B;

FIG. 8B is an enlargement of the portion marked 8B in FIG. 8A;

FIG. 8C is an enlargement of the portion marked 8C in FIG. 8A;

FIG. 9A is a planar side view of FIG. 7B

FIG. 9B is an enlargement of the portion marked 9B in FIG. 9A;

FIG. 9C is an enlargement of the portion marked 9C in FIG. 9A;

FIG. 10A is an enlargement of the portion marked 10A in FIG. 7A;

FIG. 10B is a rear perspective view of the illustration of FIG. 10A;

FIG. 11A is a perspective view of a wheeled assembly, comprising a first container articulated to a locomoting unit, and a second container articulately mounted over the first container, with a container locking latch at a closed position;

FIG. 11B is an enlargement of the portion marked 11B in FIG. 11A;

FIG. 11C is a vertical section taken along line 11C-11C in FIG. 11B;

FIG. 11D is the same as FIG. 11A, the container locking latch at an unlocked closed position;

FIG. 11E is a planar side view of FIG. 11E;

FIG. 11F is an enlargement of the portion marked 11F in FIG. 11E;

FIG. 12A is a front perspective view of a set of wall container mounts, one of each pair of two sizes;

FIG. 12B is a front perspective view of a pair of wall container mounts at a wall mounted position;

FIG. 12C is a rear perspective view of a wall container mount of FIG. 12A;

FIG. 12D is a longitudinal section along line 12C-12C in FIG. 12C;

FIG. 12E is a planar view of FIG. 12D;

FIG. 13A is a rear perspective view of a container according to an aspect of the disclosure mounted over a pair of wall container mount according to another aspect of the disclosure;

FIG. 13B is a vertical section along line 13B-13B in FIG. 13A;

FIG. 13C is an enlargement of the portion marked 13C in FIG. 13B;

FIG. 13D is a planar view of FIG. 13B;

FIG. 13E is an enlargement of the portion marked 13E in FIG. 13D;

FIGS. 14A and 14B are a perspective front view and a perspective rear view, respectively, of a containers' tower assembly mounted over a locomoting unit according to an example of the disclosure;

FIG. 15 is a perspective view of a wall mounting bracket, according to an example of the disclosure;

FIG. 16A is a perspective exploded view of the wall mounting bracket of FIG. 15;

FIG. 16B is an enlarged view of the portion marked 16B in FIG. 16A;

FIG. 16C is a sectioned view taken along line 16C-16C in FIG. 15;

FIG. 17A illustrates a set of wall mounting brackets applied to a support rack;

FIG. 17B illustrates a set of wall mounting brackets applied to a support wall, with containers mounted there over;

FIG. 17C illustrates a set of wall mounting brackets applied to a support wall;

FIG. 18A illustrates a set of wall mounting brackets applied to a hand truck, with three containers applied thereover;

FIG. 18B illustrates the hand truck of FIG. 18A, with the containers removed;

FIG. 18C is a side view of the hand truck of FIG. 18B;

FIG. 18D is an enlargement of the portion marked 18D in FIG. 18B, with the handle of the hand truck remover;

FIG. 19A is a local section along line 19A-19A in FIG. 18D;

FIG. 19B is a local section along line 19B-19B in FIG. 18B;

FIG. 19C is a local section along line 19C-19C in FIG. 18A;

FIG. 20A is a section along line 20A-20A in FIG. 18D, with the lock mechanism at an open position;

FIG. 20B is a planar side view of FIG. 20A, with a container mounted over the wall mounting bracket, and the lock mechanism at an open position;

FIG. 20C is a local, top perspective view along line 20C-20C in FIG. 18A, illustrating a container mounted over the wall mounting bracket, and the lock mechanism at an open position;

FIG. 21A is the same as FIG. 20A, however with the lock mechanism at a closed position;

FIG. 21B is the same as FIG. 20B, however with the lock mechanism at a closed position;

FIG. 21C is the same as FIG. 20C, however with the lock mechanism at a closed position;

FIG. 22 is a perspective view of a top portion of the hand truck of FIG. 18A, with an intermediate container mounted over the wall mounting bracket and the respective lock mechanism at a closed position, and a lock mechanism of an uppermost wall mounting bracket at an open position, with no container mounted thereover;

FIG. 23A is a perspective view of a monoblock wall mounting bracket, according to an example of the disclosure, and with a lock mechanism thereof at a locked position;

FIG. 23B illustrates the monoblock wall mounting bracket of FIG. 23A, with a pair of auxiliary support mounts, and with the lock mechanism at an open position; and

FIG. 23C is a planar side view of FIG. 23B.

### DETAILED DESCRIPTION OF EMBODIMENTS

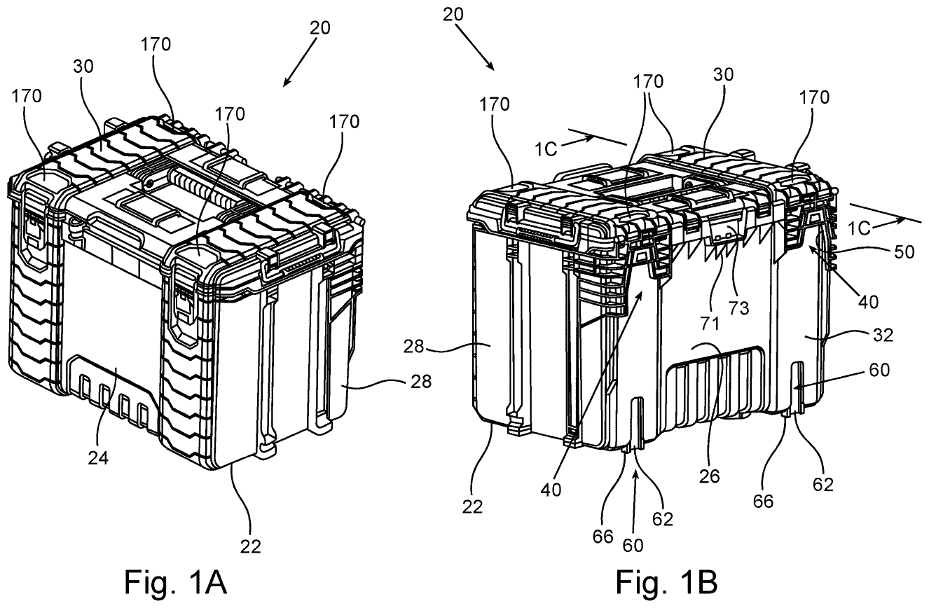

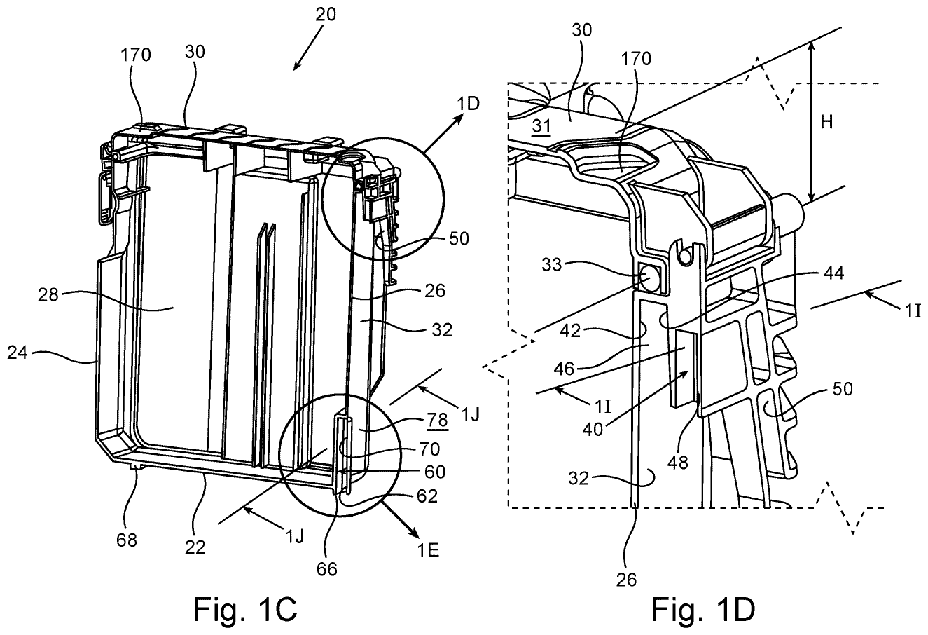

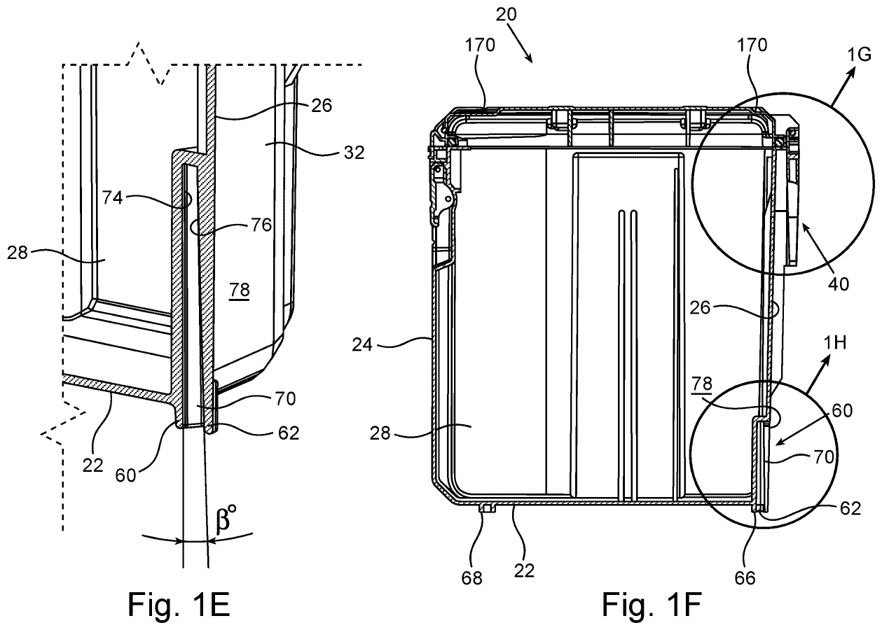

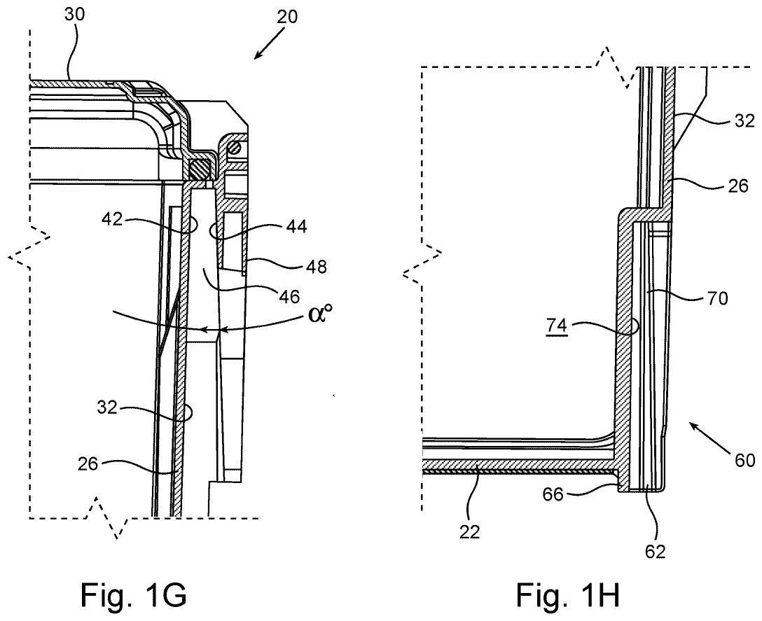

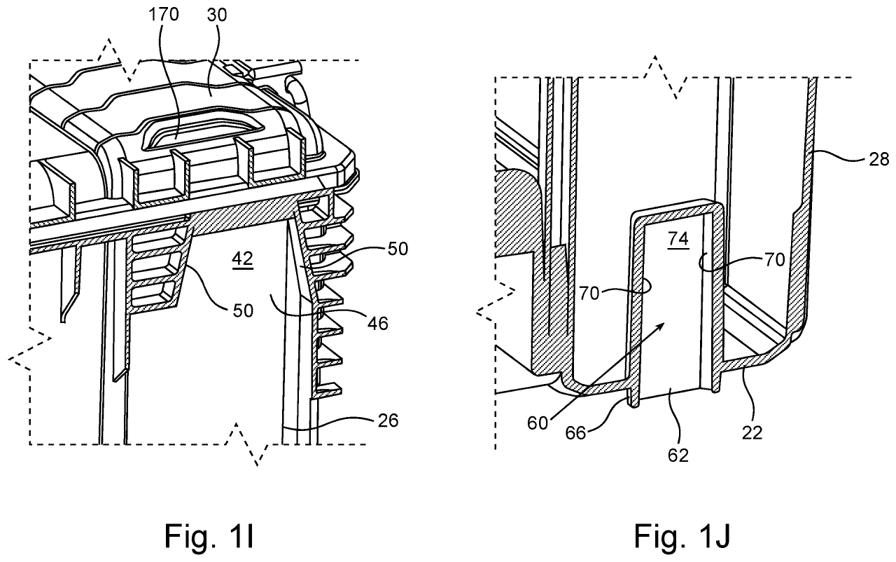

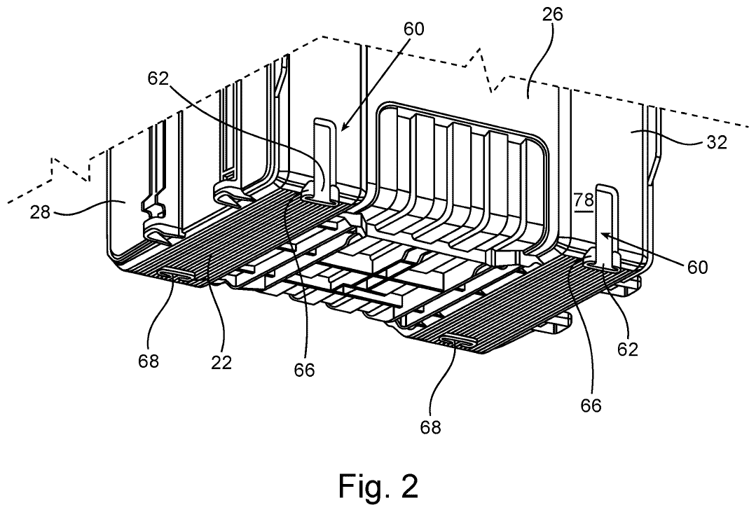

Attention is first directed to FIGS. 1A to 1E and 2, illustrating a container example according to a first aspect of the disclosure. In the illustrated example the container generally designated 20, is a toolbox comprising a base 22 with a front wall 24, a back wall 26 and a pair of side walls 28 rising from the base and defining together a container space, with a lid 30 pivotally hinged to the back wall at a top thereof about a rear top axle 33.

It is appreciated that the term ‘container’ denotes any sort of utility container, such as a toolbox, power generator, hand tool, power tool, storage unit, chest of drawers, etc., regardless of its function, shape and number of walls.

A back face 32 of the back wall 26 is configured with pair of symmetrically spaced apart top mounting sockets 40 (not seen in FIG. 1A) projecting backwards from an upper portion of the back face 32. Each mounting socket 40 is configured with a front wall portion 42 and a spaced apart back wall portion 44, with a bottom mounting opening 46 therebetween, facing downward. It is seen, best in FIGS. 1D and 1G, that the front wall portion 42 is in fact part of the back wall 26 of the container, and that the back wall portion 44 is reinforced by a double wall 48. The back wall portion 44 is supported by a pair of inclined side walls 50, tapering upwards (best seen in FIG. 1I).

Noticeable, for example in FIG. 1G, the front wall portion 42 and the spaced apart back wall portion 44 slightly taper upwards about a plane normal to the back wall, at an angle α°.

The back wall 26 is further configured with a pair of bottom mounting sockets 60 symmetrically disposed near respective back corners of the container 20, wherein each bottom mounting socket has a bottom opening 62 for receiving therein a bottom bracket as will be discussed hereinafter. The arrangement is such the bottom opening 62 extends from a rear support leg 66 (projecting downwards from the base wall 22) having a backward facing opening, wherein said rear support legs 66 together with a pair of front support legs 68 (also projecting downwards from the base wall 22) are configured for maintaining the container leveled over a flat surface.

As can be seen in FIG. 1J, inside side walls 70 of the bottom mounting sockets 60 are substantially parallel with one another, whilst at a plane normal to the back face 32, the inside front wall 74 and the inside back wall 76 of the bottom mounting sockets 60 slightly taper upwards by angle β°, as seen in FIG. 1E.

It is noted, for example in FIGS. 1B, 1C and 1F, that the back surface 78 of the back wall of the bottom mounting sockets 60 is in fact flush, i.e. coextends from the back wall surface 32, wherein the bottom mounting sockets 60 in fact project into the space of the container. Contrary thereto, the top mounting sockets 40 project backwards, i.e. rearwards from the back face 32 of the back wall 26. Further wherein the back surface 78 extends with the back face of the front wall portion 42 of the top mounting sockets 40.

Further noticeable, edges of the top mounting sockets 40 and those of the bottom mounting sockets 60 are chamfered, to facilitate easy and smooth mounting of the container 20 into mounting arresting, as will be discussed hereinafter.

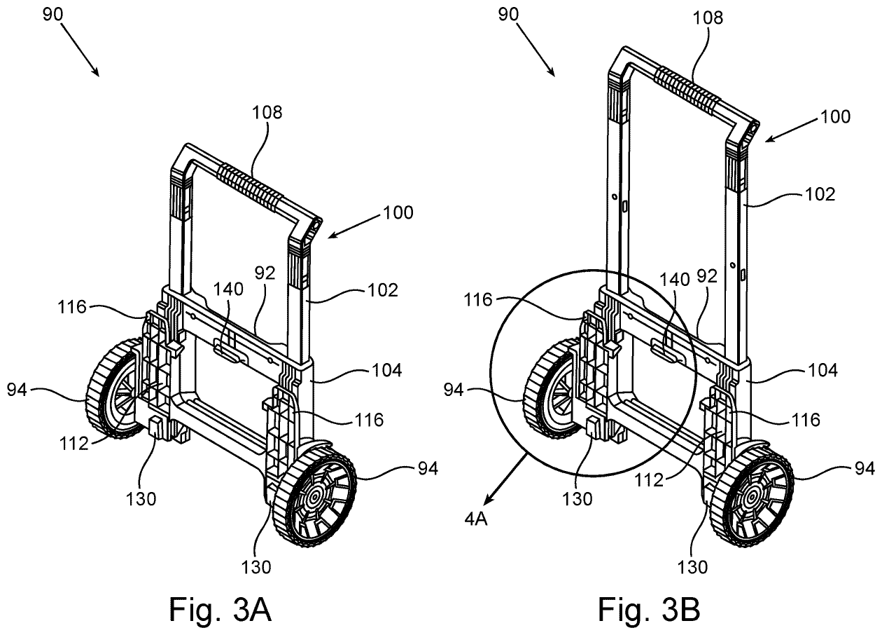

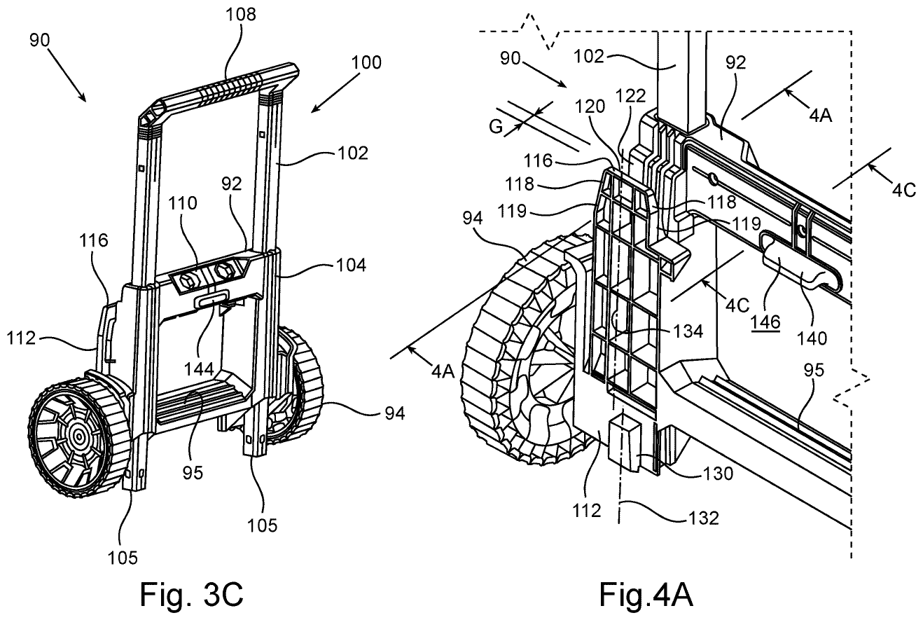

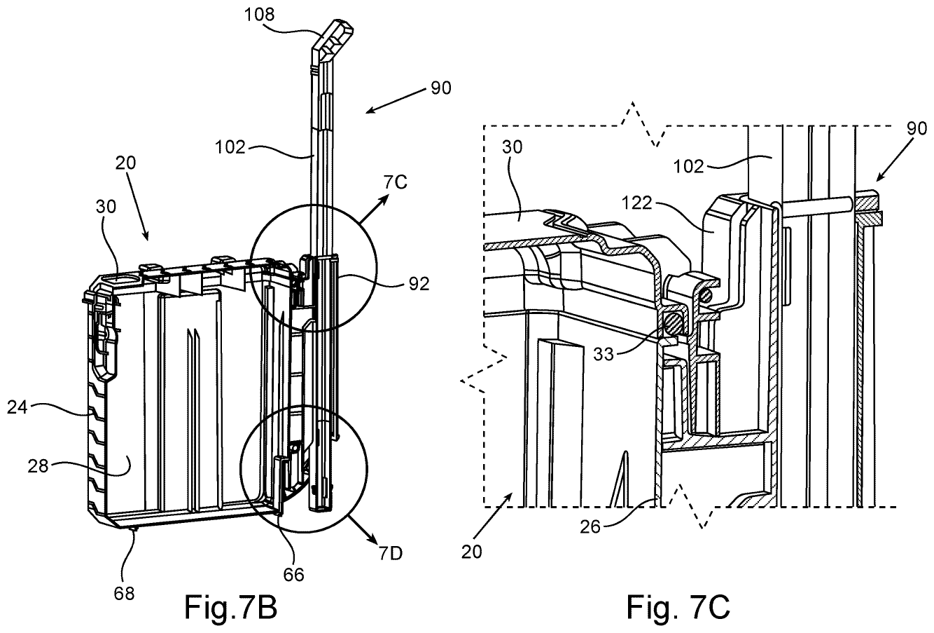

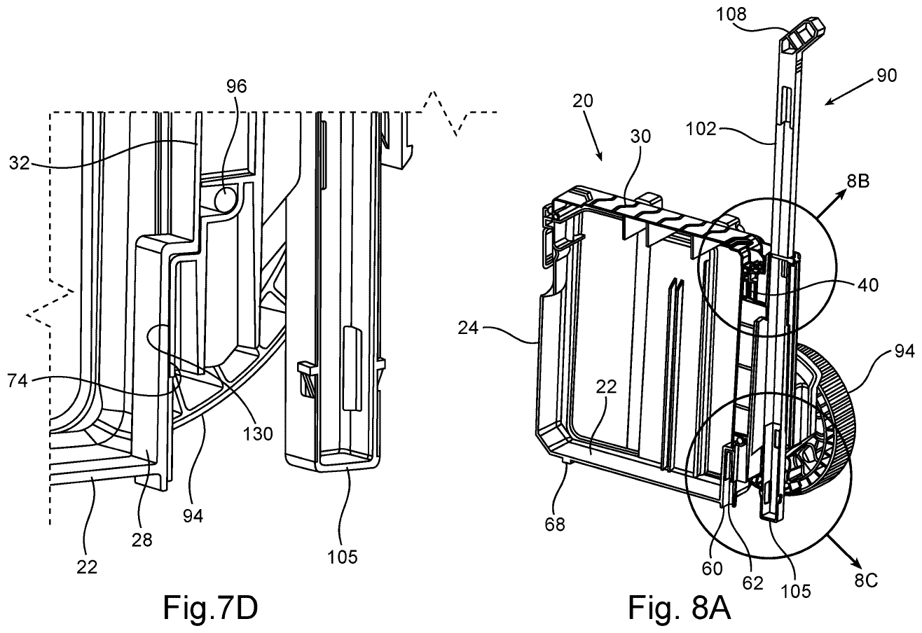

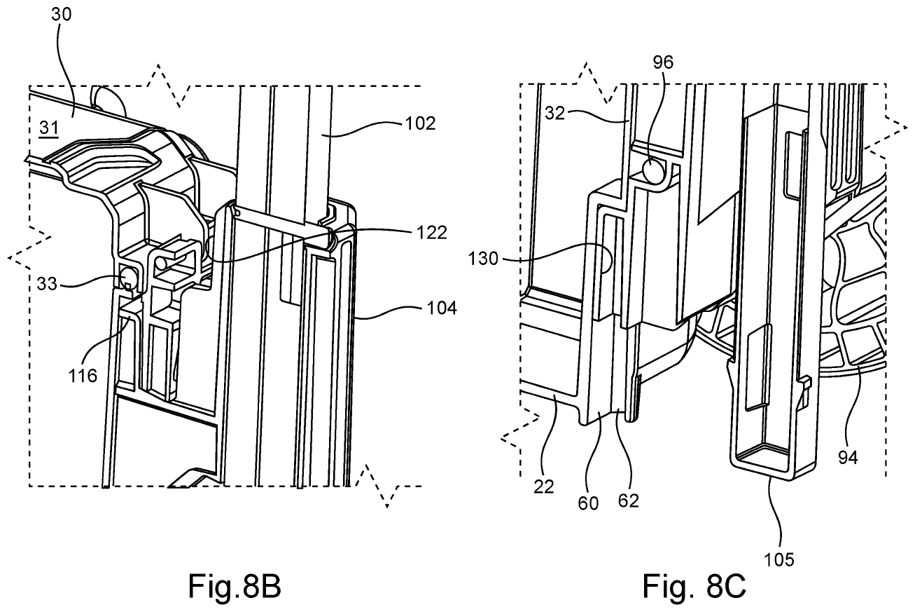

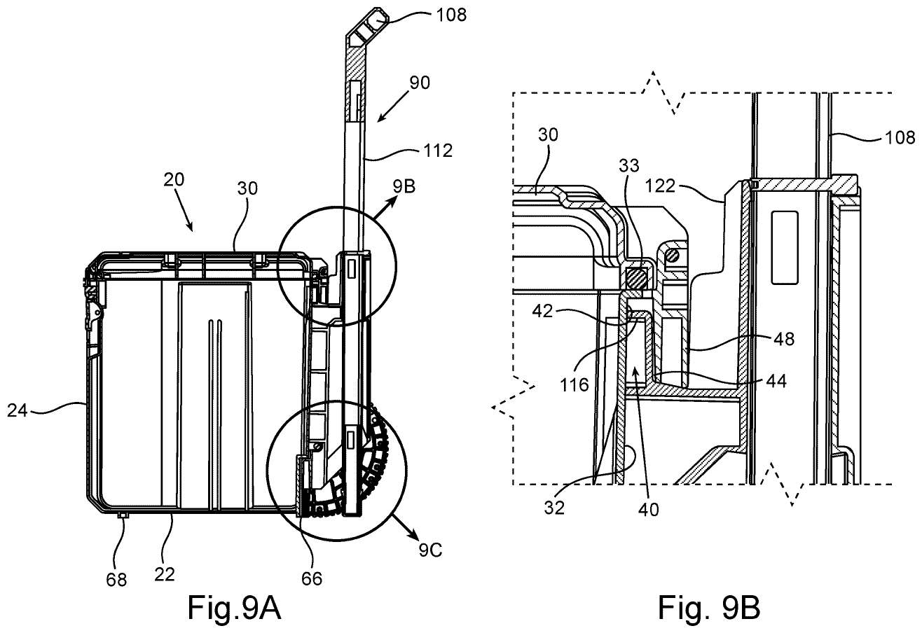

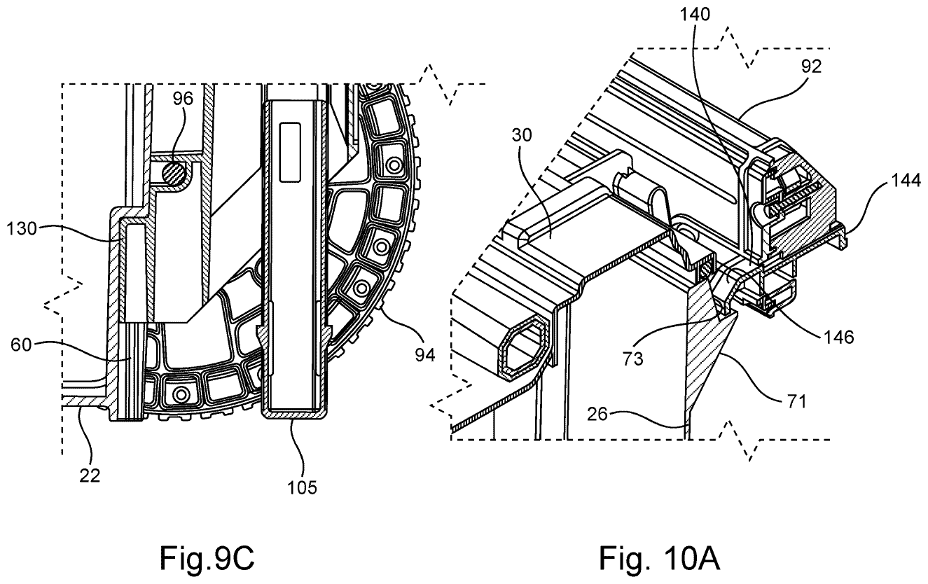

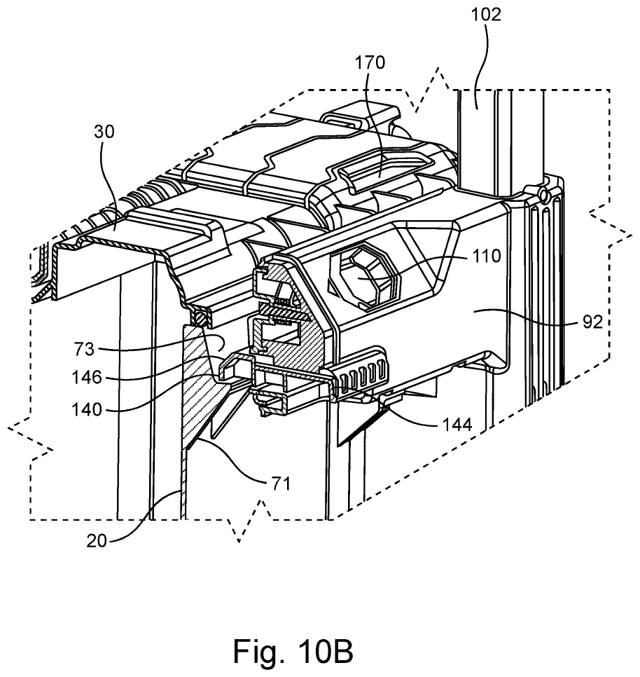

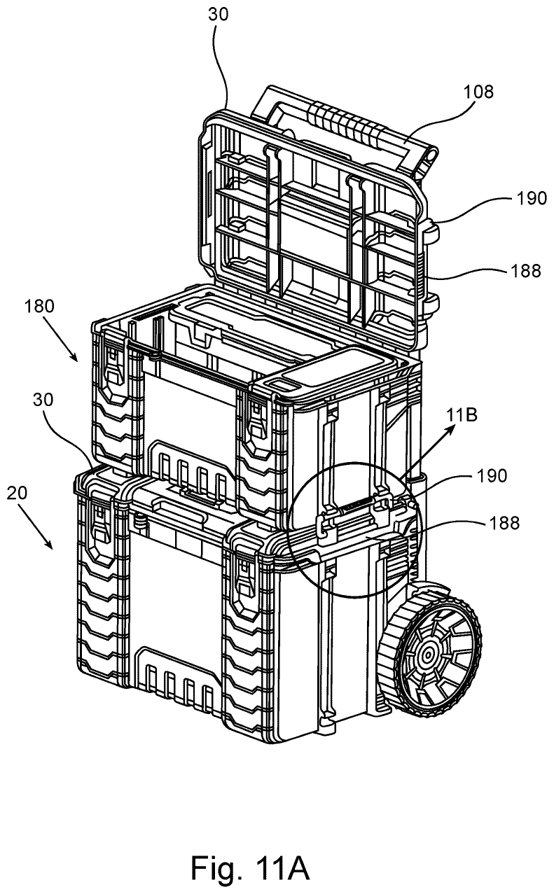

Further attention is directed to FIGS. 3A to 11F, illustrating a locomoting unit according to another aspect of the disclosure, and how a container of the disclosure is articulable thereto.

The locomoting unit generally designated 90 comprises a generally rectangle support frame 92 with a pair of wheels 94 rotatably articulated thereto about an axle 96, and with a telescopic manipulating handle assembly 100, which in the present example comprises two parallel single telescoping segments 102 slidingly receivable within a frame segment 104 integral with the support frame 92. A manipulating handle 108 extends between the telescoping segments 102 and a collapsing mechanism is configured for collapsing the telescopic handle, by a spring biased locking mechanism 110 (FIG. 3C), which subject to compressing same facilitates retraction or expansion of the telescoping segments 102 via handle 108.

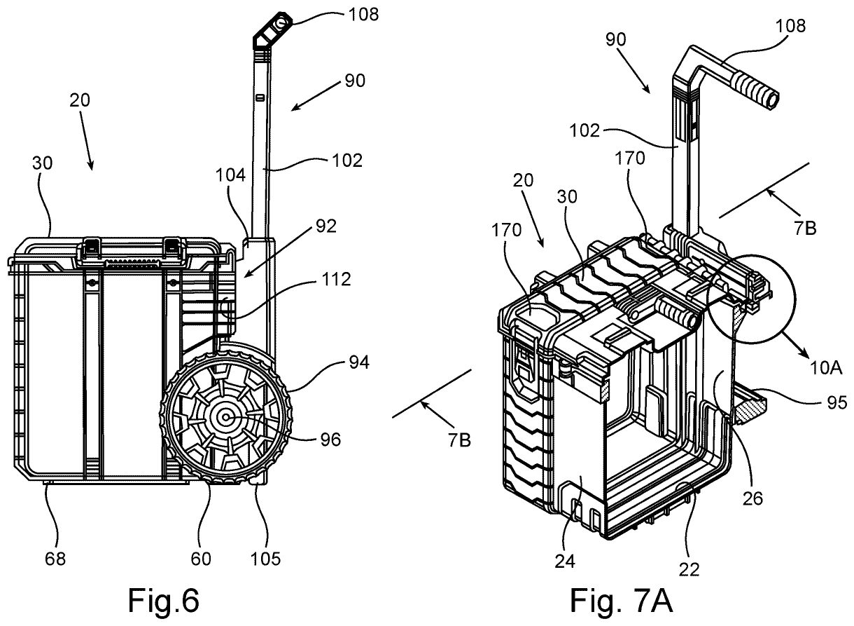

It is noted that at the retracted position of the manipulating handle assembly a bottom end 105 of the telescoping segments 102 extends equally-leveled or almost leveled with a ground contact surface of the wheels 94 (FIGS. 3C and 6). The support frame 92 is further configured with a footstep surface 95 configured for assisting an individual to tilt the locomoting unit into an inclined pulling position, and for preventing displacement of the locomoting unit 90 upon disengaging from the container, to be mentioned hereinbelow.

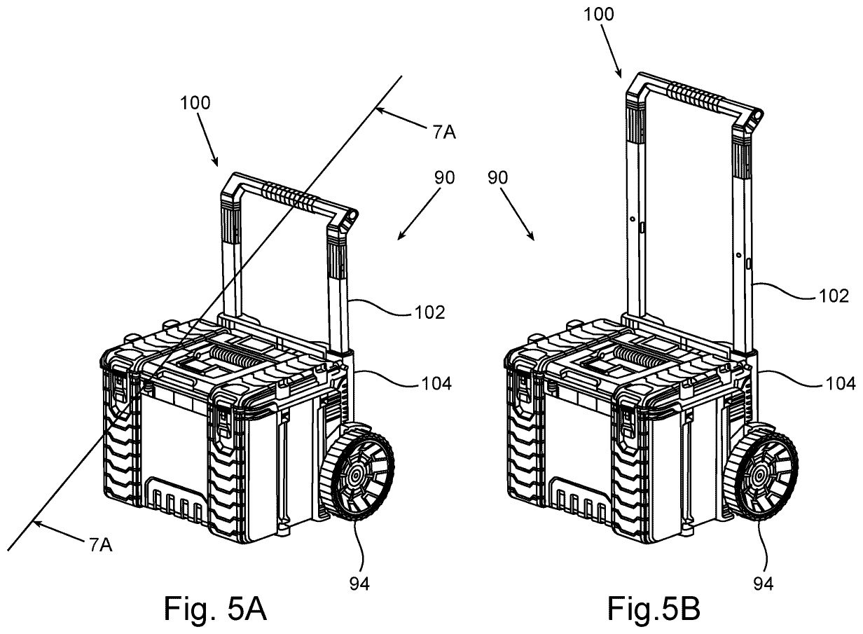

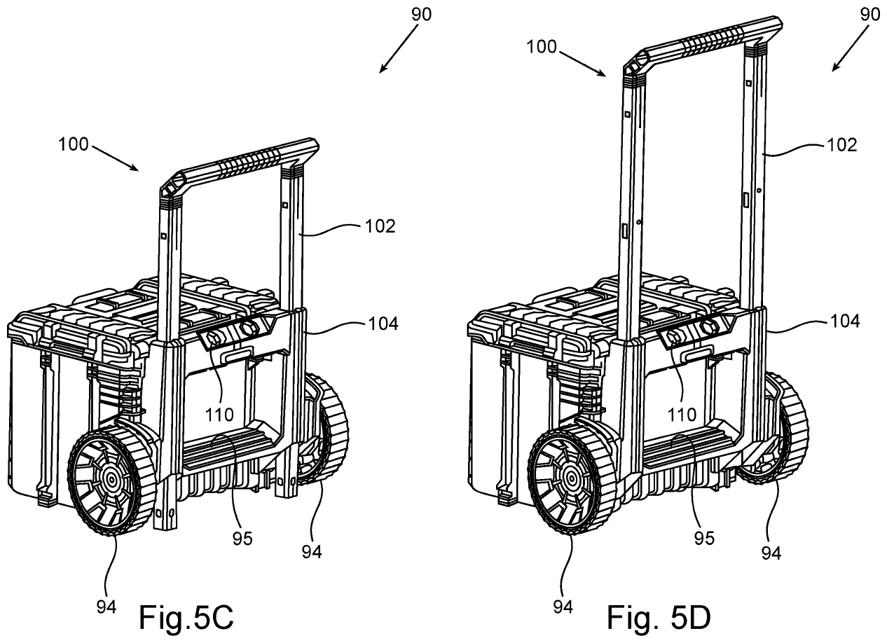

According to another example (not shown), the locking mechanism of the handle assembly can be configured at the handle portion. In FIGS. 5A and 5C the telescopic handle assembly 90 is illustrated at its retracted position, and in FIGS. 5B and 5D the telescopic handle assembly 90 is illustrated at its expanded position. Further noted, the wheel axis 96 extends behind the front surface 112 of the support frame 92

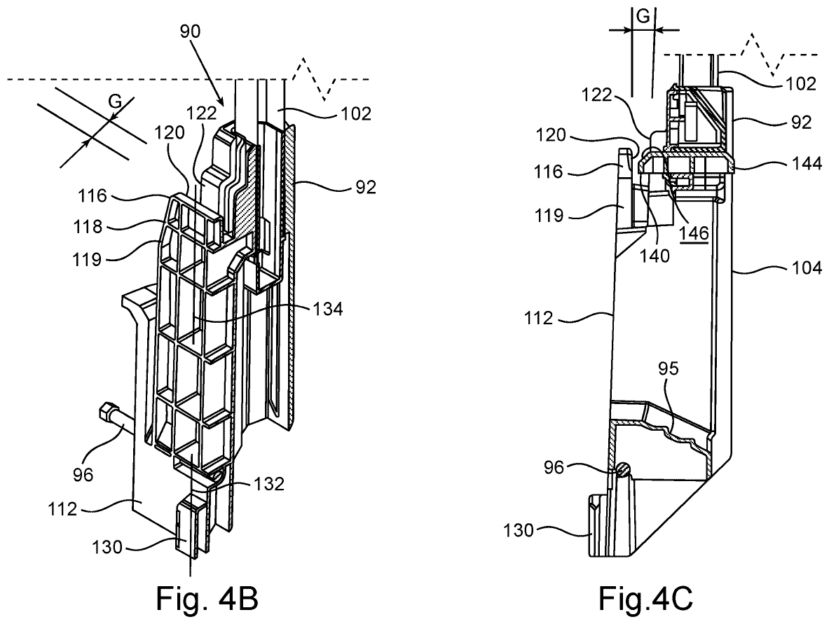

The locomoting unit 90 comprises at a front surface 122 a pair of coplanar container mounts 116 disposed at a top portion of the support frame 92, projecting upwards from the front surface. The container mounts 116 are at same level and have a generally flat shape with upward tapering side walls 118 and side projecting wings 119, wherein a back surface 120 of the container mounts 116 is spaced from the front surface 122 the support frame 92 having a gap G therebetween. It is seen, best in FIG. 4C, that a front surface face of the container mounts 116 is coextensive/flush with the front surface 122 of the support frame 92.

The support frame 92 is further configured at a bottom portion thereof with a pair of container stabilizers 130 projecting from the front surface 122 of the support frame 92 and having a T-like cross section. A longitudinal axis 132 of the container stabilizers 130 is parallel with a longitudinal axis 134 of the container mounts 116, though not necessarily coextending.

The support frame 92 of the locomoting unit 90 is further configured with a locking latch 140 (best seen in FIG. 4A) disposed between the container mounts 116 and displaceable between a retracted position and a normally projecting position behind the back surface 120 of the container mounts 116 (by a spring loaded mechanism), wherein at the projecting positioning said locking latch 140 projects into arresting engagement with a locking slot configured at a back wall of a container engaged with the locomoting unit (to be discussed hereinafter). The locking latch 140 is manually retractable by pulling it backwards at a pulling handled 144, against the spring biasing effect.

It is noted that a top, front surface 146 of the locking latch 140 is chamfered, so as to facilitate spontaneous backward displacement (contraction) at the event of a container displacing vertically downwards against said front surface 146 of the locking latch 140.

The shape, size and location of the container mounts 116 and the container stabilizers 130 correspond with those of the top mounting sockets 40 and the bottom mounting sockets 60 of the container, respectively. Accordingly, a container 20 according to the disclosure herein can be articulately mounted for locomotion to a locomoting unit 90. This takes place by positioning the back surface 32 of the container 20 against the front face 112 of the locomoting unit 90, at a position such that the bottom mounting opening 46 of the top mounting sockets 40 is disposed above the container mounts 116, whereby the container is then displaced downwards (back surface 32 sliding against front face 112) until container stabilizers 130 enter into bottom opening 62 of the bottom mounting sockets 60, and finally wherein the container reaches its final articulated position wherein at an upright position of the locomoting unit 90 the container 20 rests over the support legs 66 and 68, and is arrested by the top mounting sockets 40 container stabilizers 130.

As mentioned hereinabove, upon sliding displacement of the container downwards, a gliding surface 71 at the back of container 20 engages the chamfered surface 146 of the locking latch 140, resulting in momentarily retraction of the locking latch 140 and then spontaneous displacement into projects locking arresting within a locking slot 73 at a top portion of the back wall of the container 20, preventing spontaneous disengagement of the container from the locomoting unit. At this position, the locomoting unit 90 with the container 20 articulated thereto, can be tilted backwards, and can be wheeled over wheels 94.

Disengaging the container 20 from the locomoting unit 90 takes place in a reverse sequence of operations, namely first the locking latch 140 is manually retracted (by pulling backwards at pulling handled 144) and then the container 20 is slidingly lifted and disengaged from the locomoting unit 90. While lifting the container the individual can apply downward pressure by pressing over footstep surface 95, preventing displacement of the locomoting unit 90 (the footstep can be useful also for stabilizing the locomoting unit 90 upon articulating the container thereto).

It is seen, best in FIG. 6, that when the container 20 is articulated to the locomoting unit 90, the container is at rest over its front and back support legs 68 and 66, however wherein a bottom end 105 of the telescoping segment is in contact or almost in contact with the ground surface, as well as wheel 94.

Also noted, when the container 20 is articulated to the locomoting unit 90, the lid 30 can be pivotally displaced into its open position and be disposed at 90°, without interacting with the telescoping segments 102 of the handle 100. The lid 30 can be configured for retaining the open position by incorporation of a lid distinct position arresting mechanism (not seen).

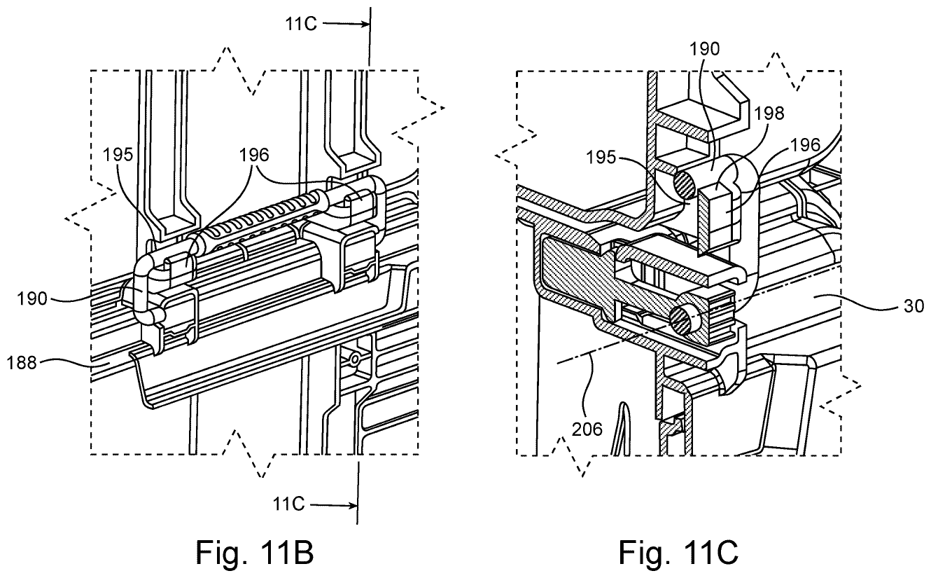

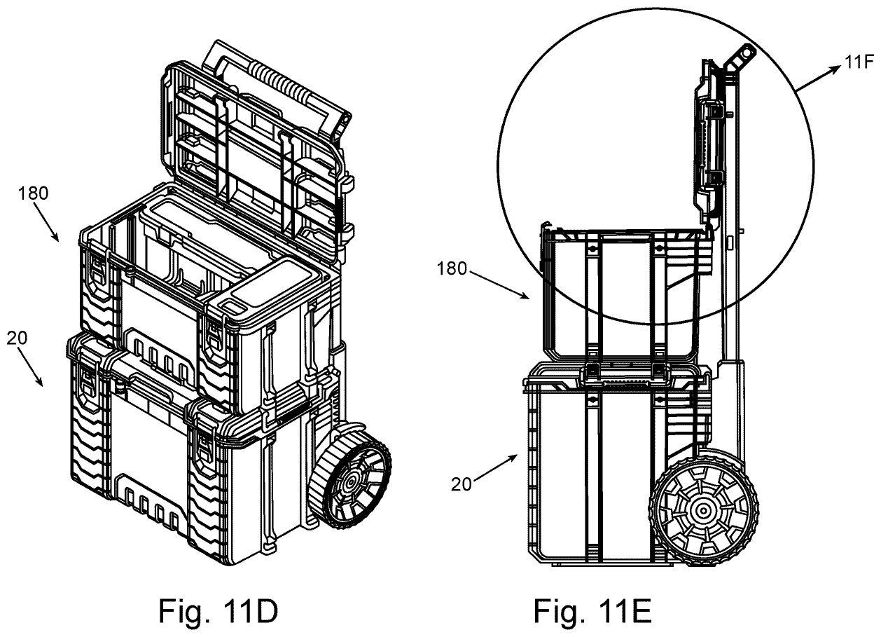

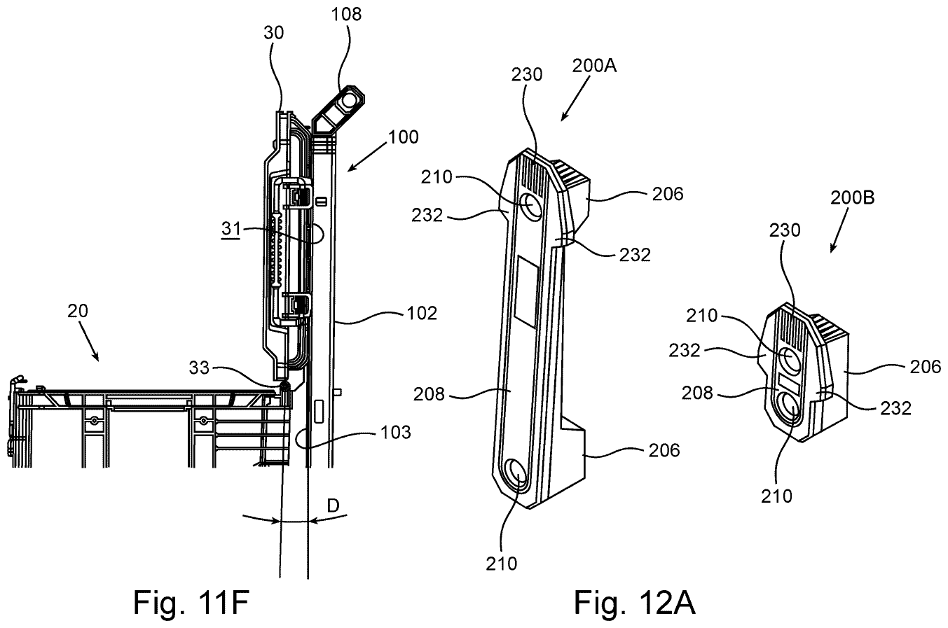

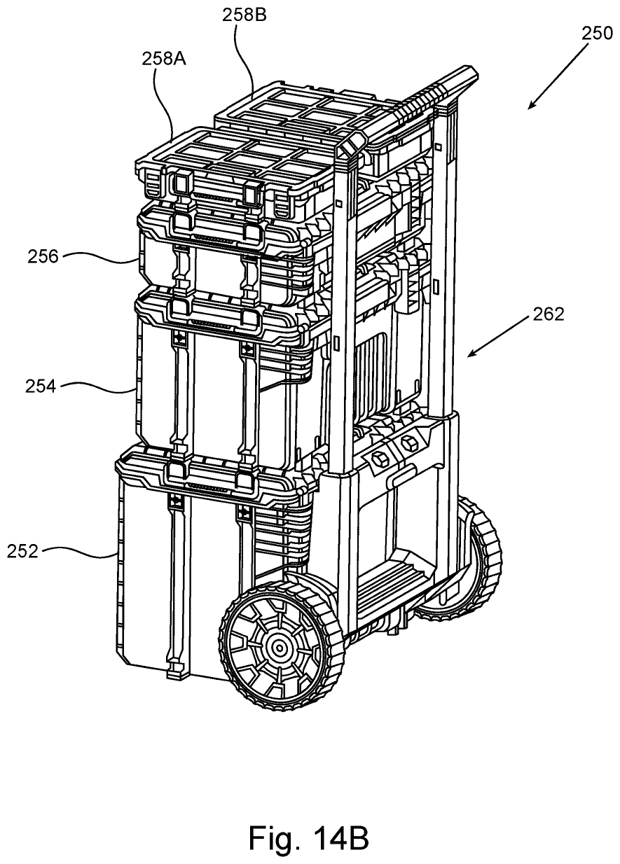

The container according to the present disclosure is suited also for stacking like containers on top of one another, with a suitable articulation therebetween, for comfortable and safe transportation. This is facilitated either as a standalone on a ground surface, or while articulated to the locomoting unit according to the disclosure. Accordingly, it is noticed that the lid 30 of the container 20 (facilitating as a ‘base container’) is configured with four depressions 170 configured for receiving and supporting support legs 66 and 68 of a second, similar container 180, mounted thereover, as illustrated for example in FIGS. 11A to 11E, and further in FIGS. 14A and 14B.

According to a particular configuration of the disclosure, the lid 30 of the container (i.e. base container 20) is configured at each of its side walls 188 with a locking handle 190 pivotally secured to the side wall 188 about a pivot axis 206, wherein the locking handle 190 is pivotable between a rest position at which it is pivoted downward and rests against a side wall portion of the lid 30, and an upright position at which it is pivoted by approximately 180° and is disposed above a surface of the lid 30. At each bottom side wall portion of the second/top container 180 there is configured a handle arresting receptacle 195 with a pair of handle arresting tongues 196 each fitted with a slanting arresting lip 198 (FIG. 11C). The arrangement is such that when the top container 180 is placed over the first/bottom container 20, the handle 190 can be pivoted into an upright, engaging position, wherein it snaps over the slanted lips 198 into the arresting position, received at the arresting receptacle 195.

The upright position of handle 190 serves for two purposes: for carrying the container when the lid secured to the container body, by lifting the container at two opposite handles 190, and for arresting to a locking portion of a second/top container.

Whilst a particular container articulation is exemplified, it is appreciated that other embodiments can be facilitated for that purpose, not shown.

As mentioned hereinbefore, whilst articulated to locomoting unit 90, the lid 30 of the container can be pivotally displaced into its open position and be disposed at 90°, without interacting with the telescoping segments 102 of the handle 100. Likewise, at the event of a second/top container articulated over the base container, the lid of said top container can be pivotally displaced into its open position and be disposed at 90°, without interacting with the telescoping segments 102 of the handle 100, as seen in FIGS. 11D to 11F, best in FIG. 11F. This is facilitated owing to projecting height H of the container's lid top surface 31 (FIG. 1D) above a center of the rear lid pivot axle 33 is similar or lesser than the distance D between the center of the rear lid pivot axle 33 to a front surface 103 of the top telescoping segments 102 of the telescopic handle 100 (FIG. 11F).

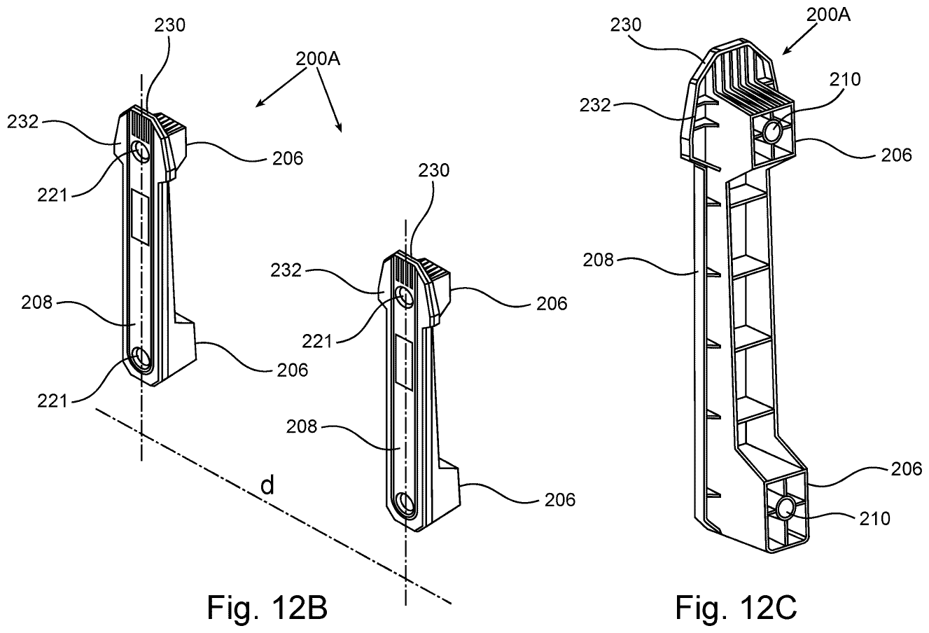

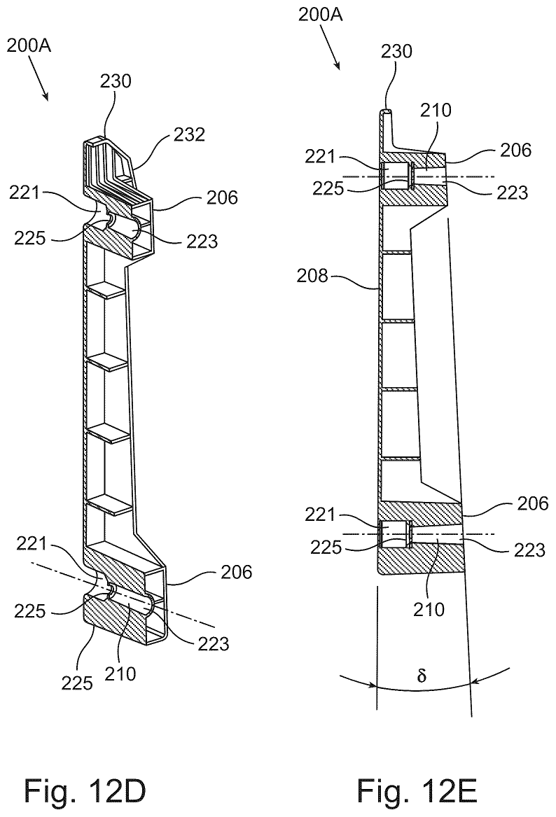

Further attention is now directed to FIGS. 12A to 12D of the drawings, directed to a third aspect of the disclosure, namely wall container mounts generally designated 200. In FIG. 12A there is illustrated a long wall mount 200A and a short wall container mount 200B, each being one of a pair as will be explained.

Each wall container mount 200 is a solid member configured at a back side thereof with a flat wall mounting surface 206 (interrupted as in wall container mount 200A, or continuous as in wall container mount 200B), and a flat front wall surface 208, with a wall articulation arrangement, namely a pair of throughgoing graded apertures 210, extending between a wider opening 221 at the front wall surface 208 and a narrower opening 223 at the wall mounting surface 206, with an annular bolt support 225 in-between.

The wall container mounts are further configured with a container mounting bracket 230 projecting upwards at a top portion and flush with the front wall 208, with lateral projecting wings 232 imparting the container mounting bracket a T-like cross section, mimicking that of the container mounts 116 discussed in connection with the locomoting unit 90, and thus configurable for arresting within a top mounting socket 40 of a container 20, as discussed hereinbefore.

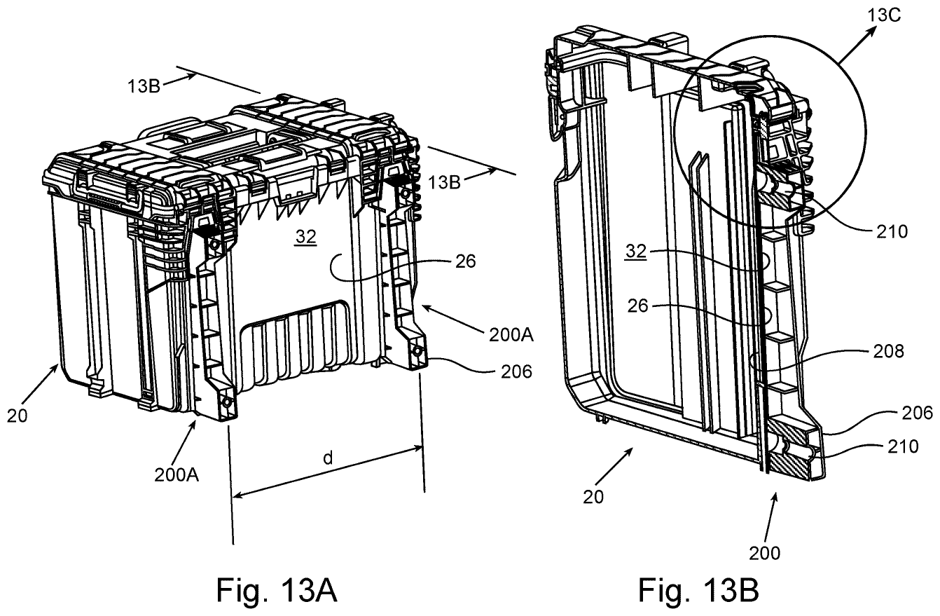

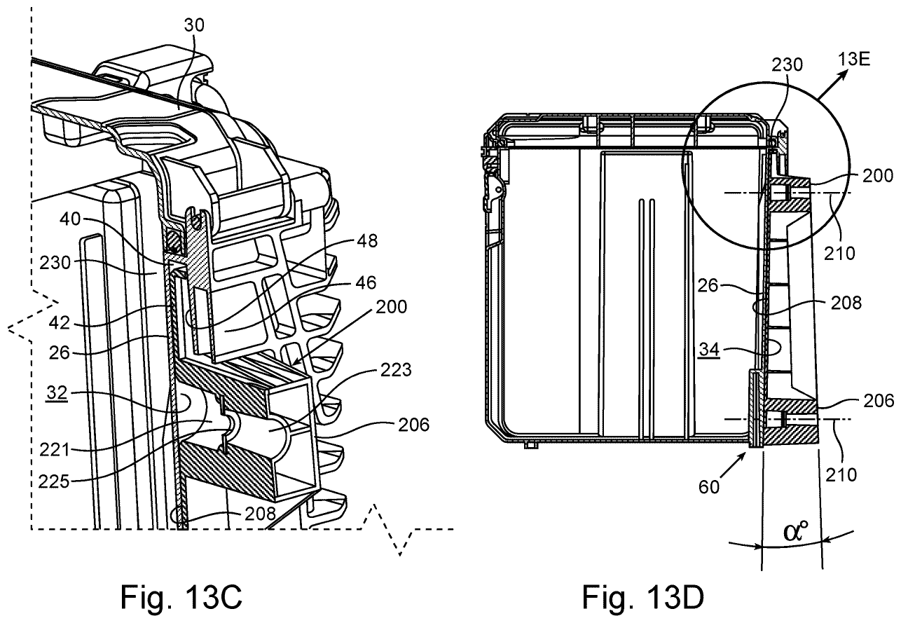

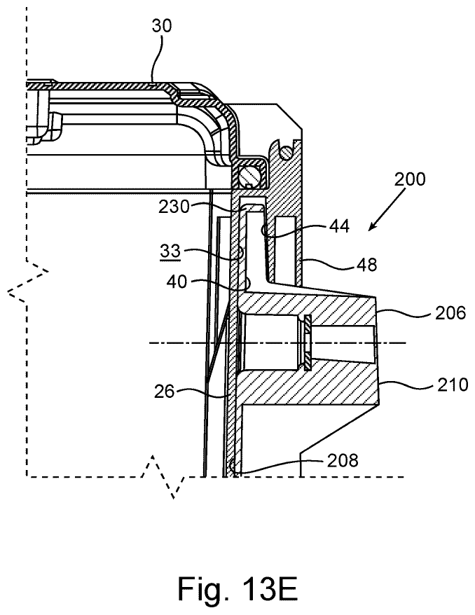

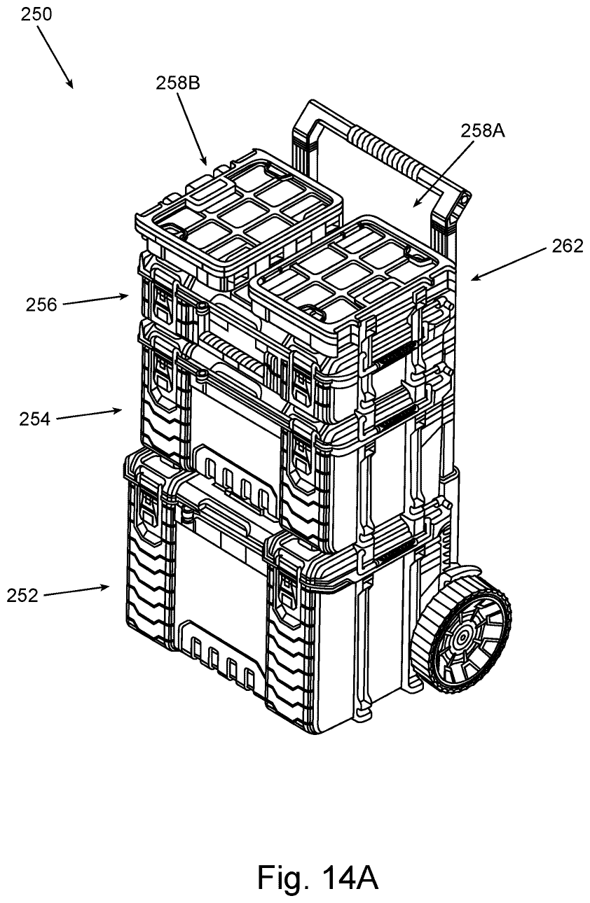

In use, as illustrated in FIG. 12B, a pair of wall mounts 200 are fixedly secured to a wall surface of any suitable carrying structure (e.g. a wall of a building/structure, a portion of a vehicle, a support structure of a cart (e.g. a hand truck), a wall of a cabinet, a work stand, etc.) at a spaced apart distance corresponding with the distance between top mounting sockets 40 of a container 20 (FIG. 13A). The wall mounts 200 are fixed to the wall surface by a pair of bolts (not shown), at an upright (vertical) position and leveled with one another, such that the container mounting bracket 230 are at the same level. For that purpose a bubble level can be used, wherein said bubble level can be integral with the wall mounts 200 (not shown). Once the wall mounts 200 are secured to the wall surface at an upright position, a container can be mounted thereon. This takes place by positioning the back surface 32 of the container 20 against the front face 208 of the wall container mount 200, at a position such that the bottom mounting opening 46 of the top mounting sockets 40 is disposed above the container mounting bracket 230, whereby the container is then displaced downwards (back surface 32 sliding against front face 208) until the container reaches its final articulated position as in FIGS. 13A to 13E).

It is seen that the wall container mount 200 tapers upward with an angle δ extending between the front face 208 and the wall mounting surface 206. The purpose of this angle is to compensate for the container's deformation under self-weight and cargo therein, wherein once suspended from the wall, the container will resume its vertical position by somewhat deformation of its back wall.

It is appreciated that the length of the wall container mounts is designed so as to conform with the height of a container intended to be suspended therefrom. A small container (in height) can be suspended from a long wall container mounts, however it is less advisable to suspend a large container from short wall container mounts. Even more so, the shape of the surface of the wall mounting surface of the wall container mounts can be flat, i.e. for articulating to a flat wall, however it can also assume other shapes, depending on the shape of the carrying wall. Also, the two (or more) wall container mounts can be integral with one another, with a bridging portion in-between (not shown). The space between neighboring wall container mounts can be used, e.g. for placing a screw box, a battery charger, etc.

Final attention is directed to FIGS. 14A and 14B of the drawings, illustrating a container set 250 comprising a plurality of different sized containers 252 to 258B and a locomoting unit 262, according to the disclosure. It is apparent that the base container 252 is attachable to the locomoting unit 262 as disclosed hereinbefore, and the containers 256 and 254 are articulated over one another likewise as discussed hereinbefore. The top containers 258A and 258B are half size foot-print containers and articulation over the container 256 can be facilitated with the same locking mechanism as discussed before, with an intermediate fixed coupler (not seen). Also appreciated, each of the containers is carriable and mountable for suspension from a wall container mount, as discussed herein.

It is appreciated that articulating a container according to the disclosure to a locomoting unit according to the disclosure or to a wall container mount according to the disclosure takes place by placing the bottom mounting opening of the container over the container mounting brackets of the locomoting unit or of the wall container mount, respectively, and slidingly displacing the container vertically downwards.

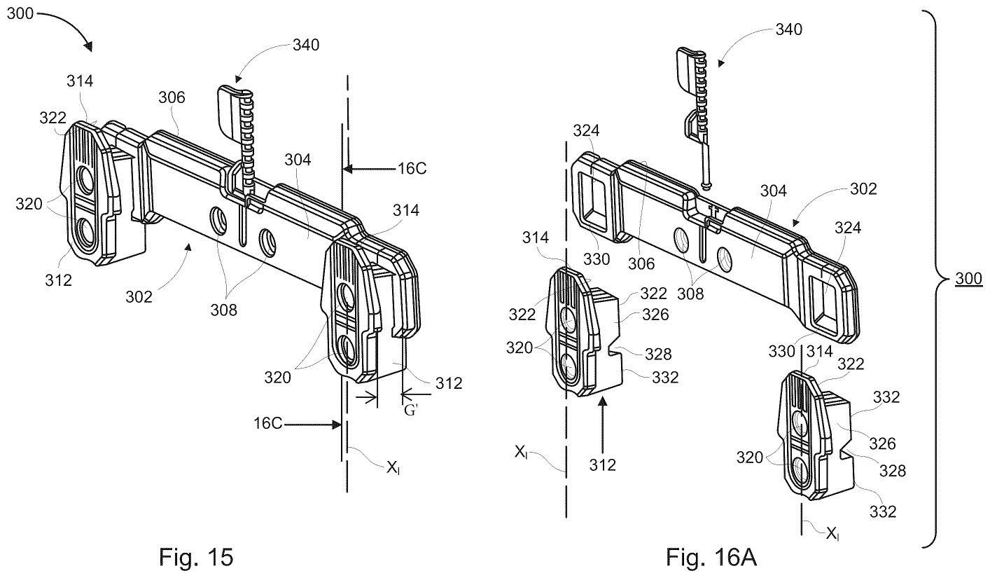

Further attention is now directed to FIGS. 15 to 23, directed to a further aspect of the disclosure, concerning a wall mounting bracket.

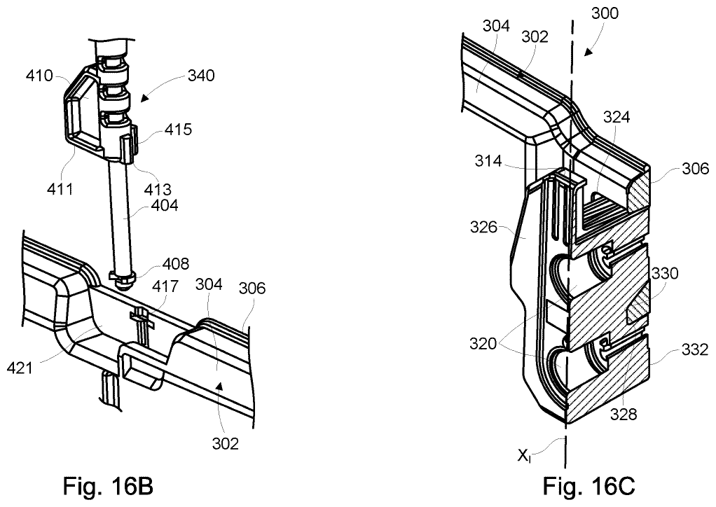

FIGS. 15 and 16 illustrate a wall mounting bracket generally designated 300, comprising a rigid elongate support bar 302 configured with a front, container mounts face 304 and a rear, flat wall articulation face 306 configurable for attaching to a bearing wall of a carrying structure as will be discussed herein below, by fasteners (not shown) applied through coupling openings 308.

The support bar 302 is configurable for positioning and supporting two container mounts 312, each configured with an upward projecting togue 314 (substantially similar with container mounts 116 discussed herein before) and configurable for arresting within a top mounting socket of a container, as discussed herein before in connection with the previous embodiments.

The container mounts 312 are each configured with a pair of apertures 320 for securing by fasteners to the carrying structure. Noticeably, the container mounts 312 are identical and extend coplanar and levelled, wherein a back surface 322 thereof extending spaced from a front surface 304 of the support bar 302 having a gap G′ therebetween (FIG. 15).

It is also noted that the support bar 302 is configured with spaced apart container mounts 312 receptacles 324 configured for receiving therein a projection 326 of container mount 312, whereby at an assembled position a grove 328 of the container mount 312 rides over a ridge 330 of the support bar 302, and whereby at the assembled position a back surface 332 of the container mount 312 is substantially flush with the flat back wall articulation face 306 of support bar 302.

Assembling a wall mounting bracket 300 takes place by first securing the support bar 302 to the support structure (by fasteners extending through openings 308), and then container mounts 312 are secured to the support structure (by fasteners extending through apertures 320), such that projection 326 are received within receptacles 324.

At the assembled position said container mounts are spaced apart from one another and disposed coplanar and with a longitudinal axis Xi thereof extending parallel with one another, said longitudinal axis defining a mounting path.

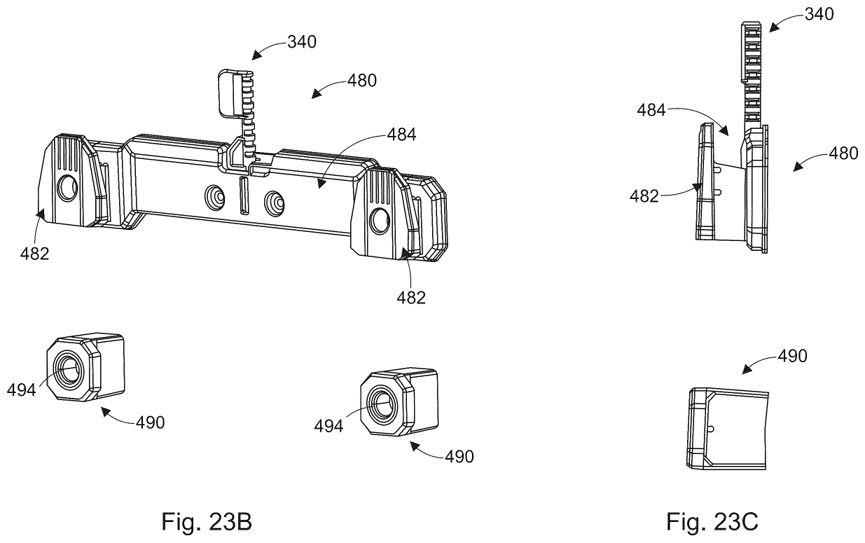

Whilst in the example of FIGS. 1A to 2 the container mounts 312 are separate from support bar 302, according to a different example the wall mounting bracket 300 can be monoblock unit, with the container mounts being integral with the support bar 302, as exemplified by FIGS. 23A-23C. It is appreciated that the support bar and the container mounts can be integrated with one another in different ways, e.g., the support bar can be slidingly engaged over the container mounts (not shown).

The support bar 302 is further configured with a lock mechanism 340, to be discussed hereinafter in detail.

As discussed herein before, the wall mounting bracket can be applied over and articulated to any structure, wherein term ‘bearing wall’ denotes any support structure suitable for articulation thereto a wall mounting bracket, e.g., a construction wall, a support frame, support studs, a hand truck, a vehicle support structure, a tool cart/box/cady, a support frame, etc.

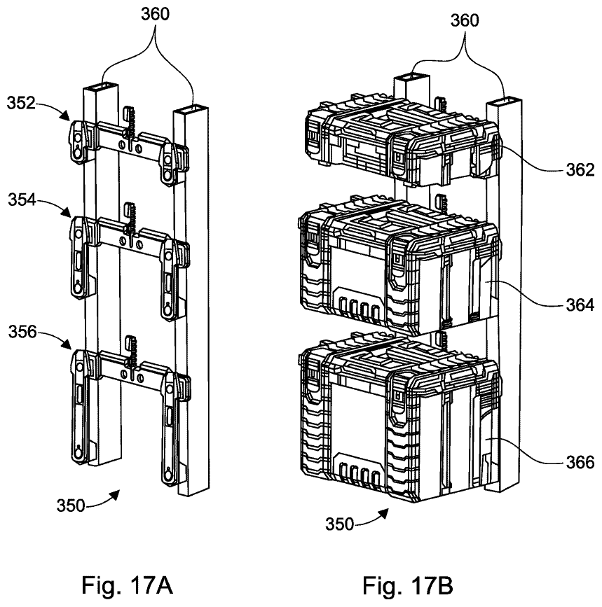

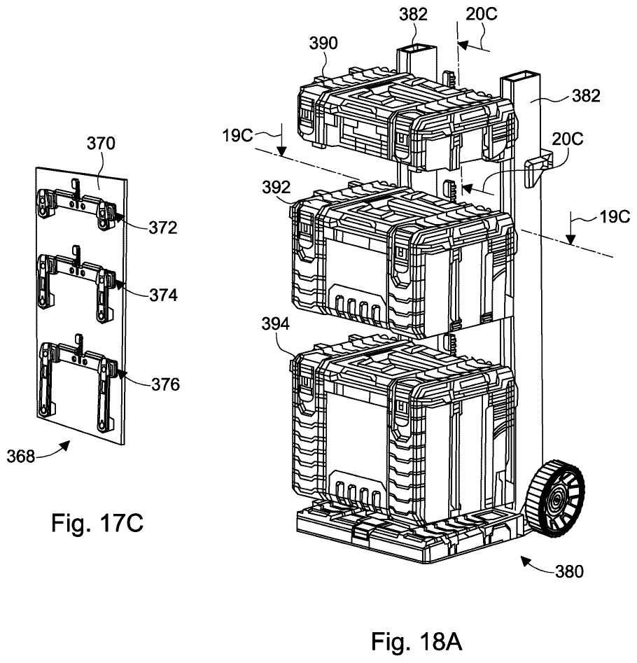

FIG. 17A illustrates a support rack 350 configured with a top mounting bracket 352, a middle mounting bracket 354 and a bottom mounting bracket 356, respectively secured to parallelly disposed support beams 360 e.g., articulated in turn to a side wall of a truck bed (not shown), where the three mounting bracket are of different size, each configured for supporting a corresponding sized container (FIG. 17B).

FIG. 17B illustrates the support rack 350 of FIG. 17A with three different size containers 362, 364 and 366 mounted over mounting brackets 352, 354 and 356, respectively, where any container can be mounted or removed irrespective if another container is mounted above or below. Mounting and removing a container takes place by displacing the container along the mounting path (longitudinal axis X₁) and as discussed herein above.

In FIG. 17C a support rack 368 is secured to a wall surface 370, wherein three support racks 372, 374 and 376 are secured directly to the wall surface 370.

Whilst each of the examples of FIGS. 17A to 17C illustrates three mounting brackets, it is appreciated that any one or more such mounting brackets, and wherein the spacing between any two mounting brackets can be different.

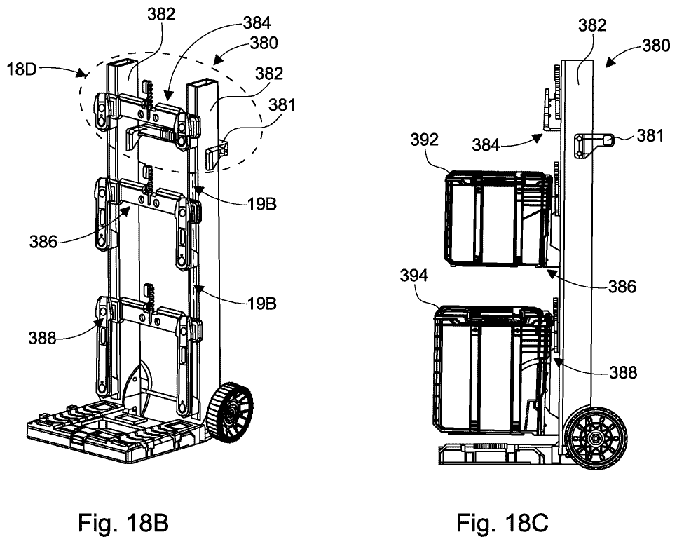

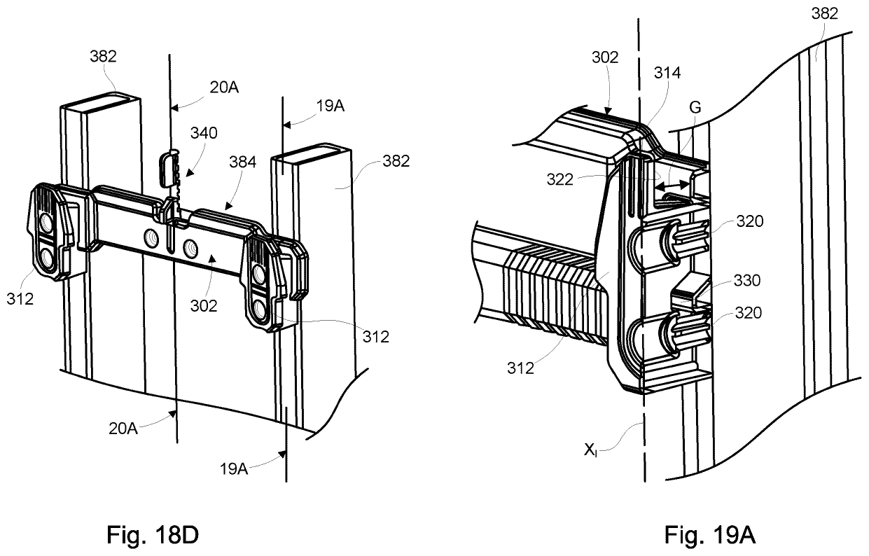

Yet an example of a bearing wall is discussed in the example of FIGS. 18 through 22, directed to a hand truck generally designated 380. Hand truck 380 comprises two parallel extending side bars 382 extending from a wheeled base and configured with a rear manipulating handle/bar 381, and with three mounting brackets 384, 386 and 388 articulated to the side bars 382 (said mounting brackets of similar construction as discussed in connection with FIGS. 15 and 16, hence like reference numbers are used). In FIG. 18A three containers 390, 392 and 394 are mounted over the mounting brackets 384, 386 and 388, respectively. In FIG. 18B the hand truck 380 is shown without any containers, and in FIG. 18C the top container 390 has been removed. It is seen that the gap G is maintained in each assembly, facilitating displacement of a container (mounting/removal) over the mounting brackets, along the mounting path extending parallel with longitudinal axis X₁.

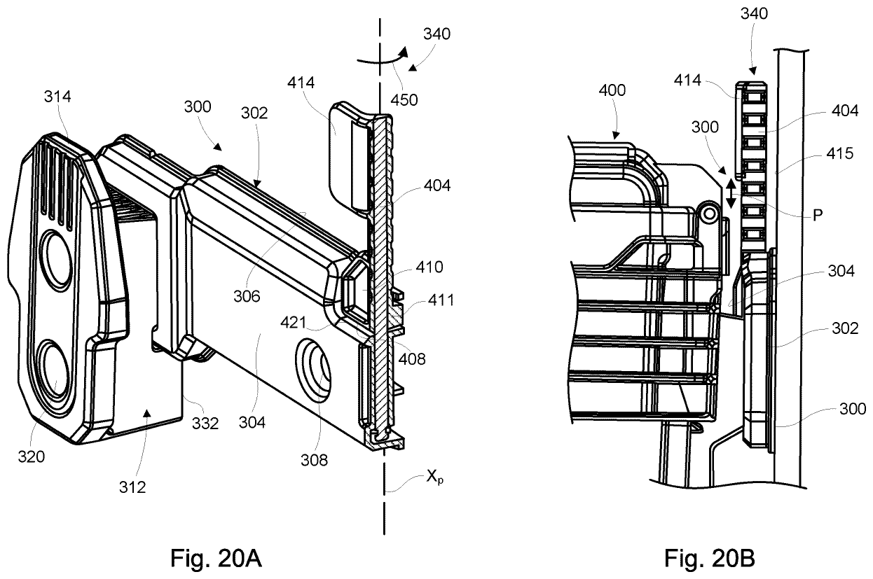

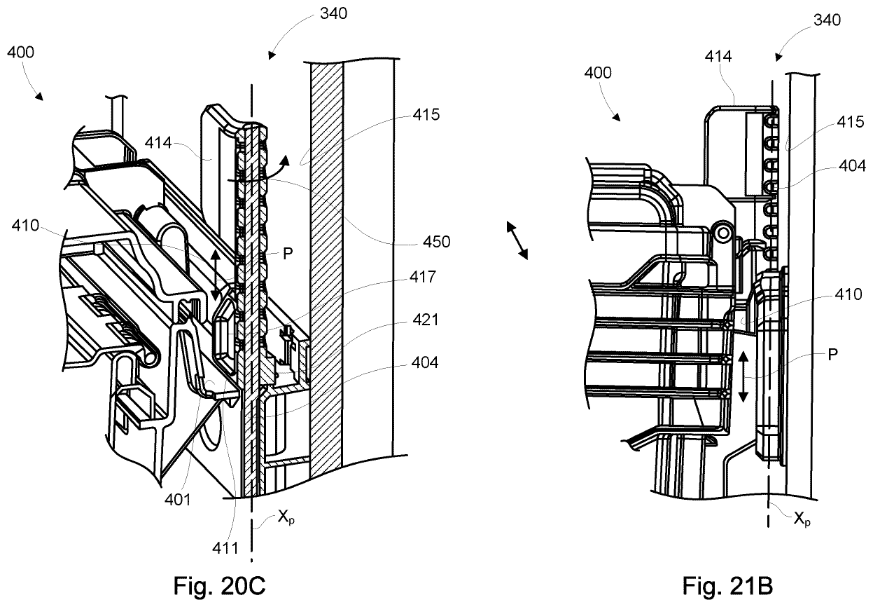

With further reference to FIGS. 20 to 23 the mounting bracket 300 is configured with a lock mechanism 340 for preventing spontaneous, unintentional displacement of a container 400 with respect to the mounting bracket 300, and in particular disengagement of the container 400 from the mounting bracket, namely, the lock mechanism is configured for selectively obstructing the mounting path of a container over said container mounts.

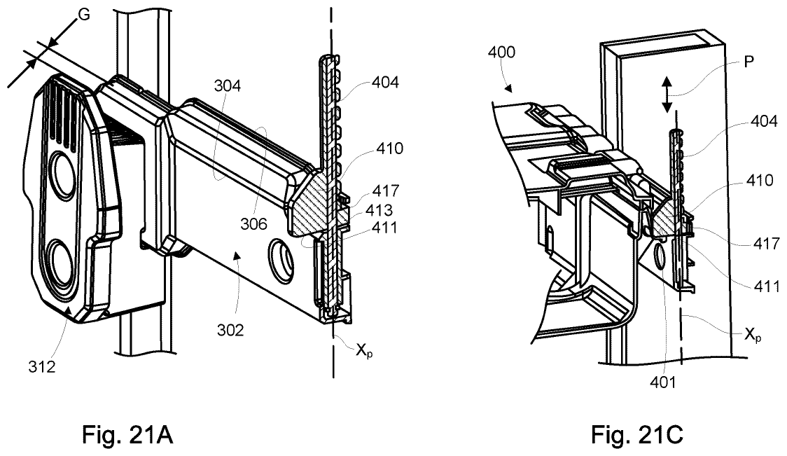

The lock mechanism 340 comprises a pin 404 vertically extending through the support bar 302, said pin 404 projecting from a top portion of the support bar 302 and being rotatably secured by a lock washer 408 at a bottom portion of the support bar 320. The lock mechanism 340 further comprises a flag-like arresting member 410 secured to the pin 404, and a manipulating member 414 (also flag-like) parallelly extending with the arresting member 410, though being offset from an axis of rotation Xₚ of the pin 404. The lock mechanism 340 can be rotated in direction of arrow 450 (FIG. 20A) between an open position wherein both the arresting member 410 and the manipulating member 414 are parallel with the support bar 302 (FIGS. 20A-20C), and a closed position (FIGS. 21A-21C) wherein both the arresting member 410 and the manipulating member 414 extend substantially perpendicular to the support bar 302.

At the open position the mounting path P (FIG. 20B) is not obstructed, whereby a container 400 can be freely mounted/unmounted, and at the closed position the mounting path is obstructed, whereby a container cannot be displaced into mounting/unmounting position over the container mounts.

The flag like manipulating member 414 extends offset from the axis of rotation Xₚ of the pin 404, so that at the open position the manipulating member is sufficiently spaced from a wall surface 415 onto which the mounting bracket is articulated, to facilitate easy finger manipulation thereof, also at the event of a mounting surface extending behind the mounting bracket.

Once a container 400 is mounted over the container mounts 312 of a wall mounting bracket 300, the lock mechanism 340 is manipulated into its closed position (by gripping manipulating member 414 and rotating the lock mechanism in the counter-clockwise direction of arrow 450), whereby a bottom surface 411 of the arresting member 410 extends over and arrests a top surface 401 at a rear face of the container 400, hence preventing displacement of the container 400 along the mounting path P.

As can be seen, best in FIG. 20A, the lock mechanism 340 is configured with a positioning arrangement for distinctively arresting it at the respective closed position and open position. Accordingly, a lower portion of the arresting member 410 is configured with two axial bulges 413 and 415, radially projecting and spaced apert by 90° from one another, and configured for snapingly arresting by a corresponding axial grove 417 configured at a wall surface of the support bar 302. Accordingly, when bulge 415 is arrested by grove 417 then the lock mechanism is secure at the open (unlocked) position, and likewise, when bulge 413 is arrested by grove 417 then the lock mechanism is secure at the locked position. noticeable, at the open position.

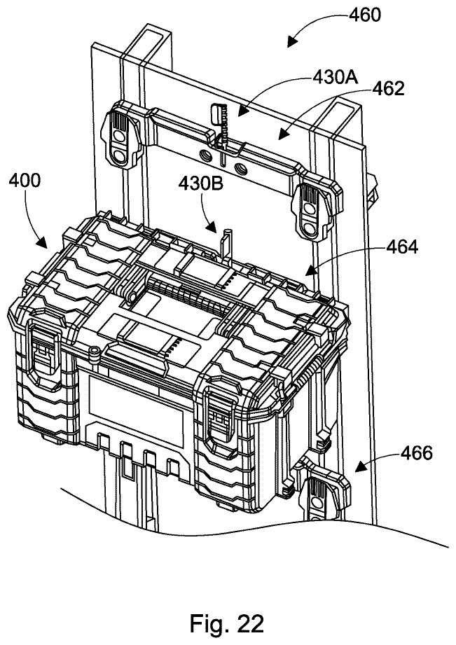

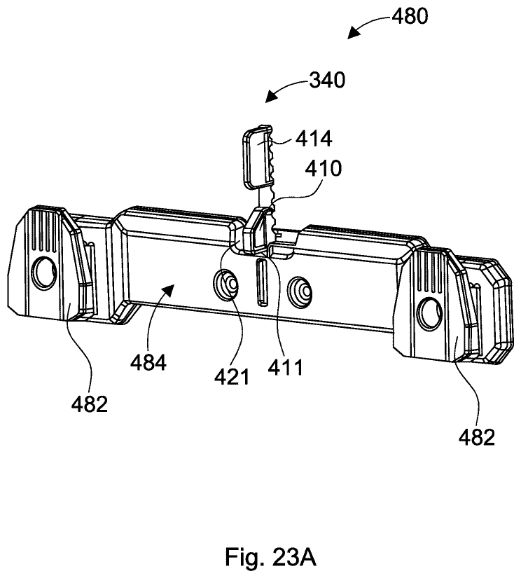

In FIG. 22 the arresting member 410 is received within a depression 421 at a top portion of the support bar 302, so it is not exposed into the mounting path and is unlikely to be accidently knocked while mounting a container.

FIG. 22 illustrates a portion of a support rack generally designated 460 and comprising a top mounting bracket 462, an intermediate mounting bracket 464 and a bottom mounting bracket 466, with a container 400 mounted over the intermediate mounting bracket 464 with the respective lock mechanism 430B at the locked position, and wherein the lock mechanism 430A of the top mounting bracket 462 is at the open position.

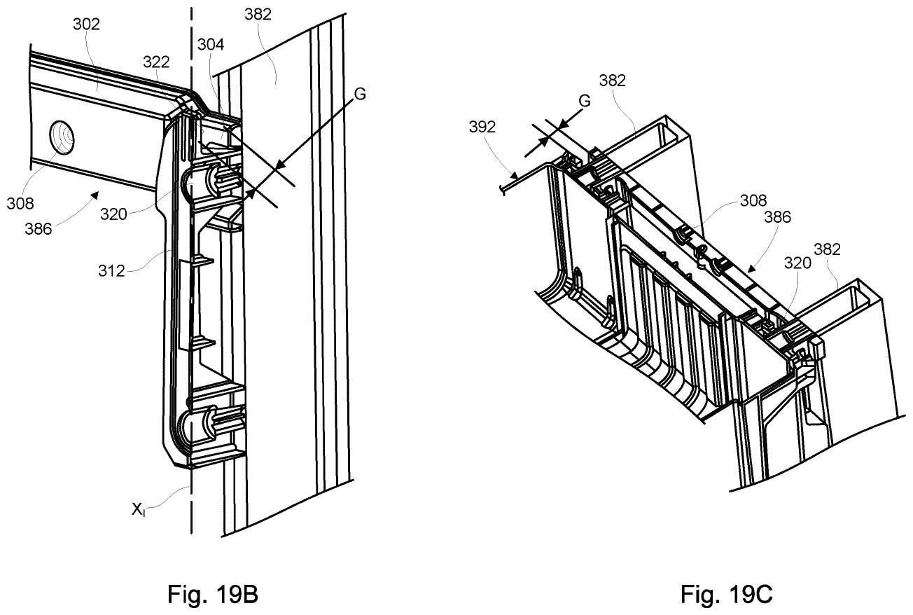

Turning now to FIGS. 23A to 23C there is illustrated mounting bracket 480 according to an embodiment of the disclosure wherein container mounts 482 are integral with a support bar 484, i.e. being a monoblock structure. Furthermore, it is seen that the container mounts 482 are short (e.g. as compared with the long container mounts of FIG. 19B), hence a pair of auxiliary support mounts 490 are provided (FIGS. 23B and 23C). auxiliary support mounts 490 being separate from the container mounts 482, and wherein each of said auxiliary support mount is configured with an aperture 494 for articulation to a bearing wall surface in alignment below a respective container mount 482, rendering the mounting bracket 480 suitable for supporting also larger containers.

1. A container assembly, comprising:
a container that comprises a back wall having a back face with at least a pair of spaced apart top mounting sockets projecting backwards from an upper portion of said back face, each mounting socket comprises at least a front wall portion and a spaced apart back wall portion, with a bottom mounting opening therebetween; and
a locomoting unit comprising a support frame that comprises a pair of wheels and a manipulating handle, at least a pair of coplanar container mounts disposed at a top portion of the support frame and projecting from a front surface thereof, each container mount having an upward projecting tongue arrestable within a top mounting socket of a container;
each of said top mounting sockets being mountable over said container mount, and
a back surface of the container mount is spaced from a front surface of the support frame, defining a gap therebetween, said gap being dimensioned to permit insertion of the top mounting socket into said container mount.

2. The container assembly according to claim 1, wherein said container comprises at least one bottom mounting socket, wherein said at least one bottom mounting socket has a bottom opening for receiving therein a bottom bracket.

3. The container assembly according to claim 1, wherein said container comprises, at a back wall thereof, a locking slot for arresting engagement with a locking latch slidably displaceable therein.

4. The container assembly according to claim 1, wherein the back wall portion of the mounting socket is shorter than a front wall portion thereof.

5. The container assembly according to claim 1, wherein the front wall portion of the mounting sockets extends coplanar with an outside face of a back wall of the container.

6. The container assembly according to claim 1, wherein the front wall portion of the mounting socket is part of the back surface of the back wall.

7. The container assembly according to claim 1, wherein the mounting socket comprises an open portion at a back wall thereof, and is mountable over a wall container mount having a T-like cross section, when the container is removed from the locomoting unit, wherein the top mounting sockets being configured to receive said wall container mount.

8. The container assembly according to claim 1, wherein the container comprises a lid pivotally hinged at a top of the back wall, and being displaceable between a closed position at which it bears over a top end of walls of the container, and at least a first open position at which it is disposed at an upright position.

9. The container assembly according to claim 2, wherein a longitudinal axis of the top mounting sockets and of the at least one bottom mounting socket are parallel with one another.

10. The container assembly according to claim 1, wherein the outside, back wall surface of the bottom mounting socket can extend at the same plane of an outside face of the back wall of the container.

11. The container assembly according to claim 2, wherein the outside, back wall surface of the bottom mounting socket extends at the same plane of an inside front wall of the top mounting sockets.

12. The container assembly according to claim 2, wherein the bottom mounting socket comprises a T-like cross section.

13. The container assembly according to claim 2, wherein a sliding axis of the top mounting sockets coincides with a sliding axis of the bottom socket.

14. The container assembly according to claim 2, wherein the front wall portion of the mounting socket extends flush with a back face of a back wall of the container.

15. The container assembly according to claim 2, wherein the back wall portion of the bottom mounting socket extends flush with a back face of a back wall of the container.

16. The container assembly according to claim 1, wherein a longitudinal axis of each of the pair of top mounting sockets is inclined with respect to the back wall of the container, whereby said longitudinal axis intersects a plane of the back wall of the container.

17. The container assembly of claim 1, wherein in each mounting socket
the front wall portion and the back wall portion are connected by side walls extending therebetween, and a top wall portion,
the back wall portion extending continuously between the side walls, and
the front wall portion, the back wall portion, the side walls and the top wall portion defining together a confined space along a longitudinal axis, and the bottom mounting opening is defined therebetween and opening into said confined space.
